(19) United States
(12) Patent Application Publication
(10) Pub. No.: US 2026/0339799 A1
(43) Pub. Date: Oct. 29, 2026

(54) PARALLEL PROCESSING OF RESOURCE USAGE COMPUTATIONS ACROSS REALMS

(71) Applicant: Oracle International Corporation, Redwood Shores, CA (US)

(72) Inventors: Rohit Shamasundara Shetty, Apex, NC (US); Amit Kumar Singh, Indore (IN)

(73) Assignee: Oracle International Corporation, Redwood Shores, CA (US)

(21) Appl. No.: 19/189,511

(22) Filed: Apr. 25, 2025

(51) Int. Cl. G06F 11/30

(52) U.S. Cl. CPC G06F 11/3034; G06F 11/3006

(57) ABSTRACT

Techniques for implementing parallel processing of resource usage computations across realms are disclosed. In an example method, data is received by a computing system from datacenters in one or more realms that identify a value computed in each respective realm for resources in the realms, where the value is computed in each respective realm using usage value parameters associated with a tenancy for a customer associated with the realm. The datacenters of each realm are restricted from communicating datacenters in other realms. The computing system determines, for a first tenancy of the customer associated with a first realm, based on at least one of the values, that a new usage value parameters apply for the customer instead of an existing usage value parameters. The computing system communicates data to the datacenter in the first realm that identifies the new usage value parameters.

### FIELD

The present disclosure relates generally to cloud computing and datacenters, and more particularly to techniques for performing distributed parallel processing of resource usage-related computations in datacenters in different realms that are isolated from each other.

### BACKGROUND

Cloud service providers (“CSPs”) may group regionally located network resources into logical subdivisions such as realms. A realm is a logical collection of one or more regions. For CSPs that provide cloud resources to customers, tracking the usage of such resources between different datacenters, regions, realms, or other logical network groupings can present a formidable challenge. The challenge is made even more complicated when a customer uses multiple realms since the realms are isolated from each other and cannot communicate with each other.

The CSP can use various approaches for tracking or valuating the usage of resources for the customer. In some existing approaches, resource usage for a CSP customers can be tracked as resources are consumed, without any pre-arranged commitment. Some other existing approaches require CSP customers to commit to a certain amount of resource usage ahead of time for a given period. The CSP then allocates resources in accordance with such commitments. The resource commitments can then be debited, at the customer or tenancy level, as resources are consumed. This existing approach is however very static in nature and places an upper bound on resource consumption for the given period.

In real world scenarios, resource commitments are rarely straightforward. For example, resource commitments may involve tiered thresholds of usage that vary among customers, realms, other network subdivisions, resources, applications, and so on. Existing approaches for tracking resource usage lack methods for communicating information about computing resource usage that can change under various circumstances and vary across logical entities such as realms, other network subdivisions, and resources.

### BRIEF SUMMARY

Various embodiments are described herein, including methods, systems, non-transitory computer-readable storage media storing programs, code, or instructions executable by one or more processors, and the like. Some embodiments may be implemented by using a computer program product, comprising computer program/instructions which, when executed by a processor (e.g., a CPU, a GPU), cause the processor to perform any of the methods described in the disclosure. The computer program and instructions may be stored on a non-transitory storage medium. The features disclosed in each embodiment can be combined in a relevant manner.

The present disclosure relates generally to cloud computing and datacenters, and more particularly to techniques for performing distributed parallel processing of usage-related computations in datacenters in different realms. Techniques are disclosed for performing processing, including processing performed in parallel, related to management and usage valuation of resources spread across datacenters distributed in different realms that are isolated from each other.

In an example method, a computing system receives first data from a first datacenter in a first realm, the first data identifying a first value computed in the first realm for usage of a first resource by a first tenancy in the first realm, in which the first value is computed in the first realm using first usage value parameters associated with the first tenancy for the first realm, the first realm including a first set of datacenters including the first datacenter. The computing system then receives second data from a second datacenter in a second realm, the second data identifying a second value computed in the second realm for usage of a second resource by a second tenancy in the second realm, in which the second value is computed in the second realm using second usage value parameters associated with the second tenancy for the second realm, the second realm including a second set of datacenters including the second datacenters, where the second set of datacenters are restricted from communicating with the first set of datacenters. Then computing system next determines that the first tenancy in the first realm and the second tenancy in the second realm are associated with a first customer. The computing system determines based on at least one of the first value or the second value, that third usage value parameters apply for the first customer instead of the first usage value parameters. The computing system then communicates third data to the first datacenter in the first realm, in which the third data identifies the third usage value parameters.

An example non-transitory computer-readable storage medium stores instructions that, when executed by one or more processors, cause the one or more processors to perform operations including: receiving first data from a first datacenter in a first realm, the first data identifying a first value computed in the first realm for usage of a first resource by a first tenancy in the first realm, in which the first value is computed in the first realm using first usage value parameters associated with the first tenancy for the first realm, the first realm including a first set of datacenters including the first datacenter; receiving second data from a second datacenter in a second realm, the second data identifying a second value computed in the second realm for usage of a second resource by a second tenancy in the second realm, in which the second value is computed in the second realm using second usage value parameters associated with the second tenancy for the second realm, the second realm including a second set of datacenters including the second datacenters, where the second set of datacenters are restricted from communicating with the first set of datacenters; determining that the first tenancy in the first realm and the second tenancy in the second realm are associated with a first customer; determining, based on at least one of the first value or the second value, that third usage value parameters apply for the first customer instead of the first usage value parameters; and communicating third data to the first datacenter in the first realm, in which the third data identifies the third usage value parameters.

An example system includes one or more processors and one or more computer-readable storage media storing instructions which, when executed by the one or more processors, cause the one or more processors to perform operations including: receiving first data from a first datacenter in a first realm, the first data identifying a first value computed in the first realm for usage of a first resource by a first tenancy in the first realm, in which the first value is computed in the first realm using first usage value parameters associated with the first tenancy for the first realm, the first realm including a first set of datacenters including the first datacenter; receiving second data from a second datacenter in a second realm, the second data identifying a second value computed in the second realm for usage of a second resource by a second tenancy in the second realm, in which the second value is computed in the second realm using second usage value parameters associated with the second tenancy for the second realm, the second realm including a second set of datacenters including the second datacenters, where the second set of datacenters are restricted from communicating with the first set of datacenters; determining that the first tenancy in the first realm and the second tenancy in the second realm are associated with a first customer; determining, based on at least one of the first value or the second value, that third usage value parameters apply for the first customer instead of the first usage value parameters; and communicating third data to the first datacenter in the first realm, in which the third data identifies the third usage value parameters.

### BRIEF DESCRIPTION OF THE DRAWINGS

FIG. 1 depicts a system implementing for parallel processing of resource usage computations across realms, according to some examples of the present disclosure.

FIG. 2 depicts a simplified flowchart showing a method for parallel processing of resource usage computations across realms, according to some examples of the present disclosure.

FIG. 3 depicts a simplified flowchart showing a method for providing reservation requests for parallel processing of resource usage computations across realms, according to some examples of the present disclosure.

FIG. 4 depicts a simplified flowchart showing a method for single-realm datacenter resource usage management, according to some examples of the present disclosure.

FIG. 5 depicts a simplified flowchart showing a method for providing multi-resource data for parallel processing of resource usage computations across realms, according to some examples of the present disclosure.

FIG. 6 is a block diagram illustrating one pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates generally to cloud computing and datacenters, and more particularly to techniques for performing distributed parallel processing of usage-related computations in datacenters in different realms. Techniques are disclosed for performing processing, including processing performed in parallel, related to management and usage valuation of resources spread across datacenters distributed in different realms that are isolated from each other.

Techniques are described for managing the usage of resources for a customer of a cloud service provider (“CSP”), where the resources may be spread across and consumed by the customer across datacenters in multiple realms. In certain implementations, processing is performed in parallel at each realm, where the processing comprises monitoring and tracking the usage of resources allocated to the customer at each realm and performing usage evaluations for the realm based upon the resource usage. Results from the parallel processing performed at the realm-level are then collated to determine the resource usage and evaluations across realms. Based upon the cross-realm results and further based upon usage information configured for the customer (e.g., based upon an service level agreement (“SLA”) between the customer and the CSP), new parameters for usage evaluation are determined and pushed down to the individual realms for use by each realm for the realm-level usage evaluations.

In general, a cloud services provider (“CSP”) may provide one or more cloud services to subscribing customers using resources and infrastructure provided by the CSP. These resources may include compute resources (e.g., CPUs, GPUs, host machines), memory resources, networking resources, and other types of resources. A customer can subscribe to one or more cloud services provided by the CSP. The customer can be any entity such as an individual, an organization, an enterprise, and the like. When a customer subscribes to or registers for a service provided by a CSP, a tenancy or an account is created for that customer. The customer can then, via this account, access the subscribed-to one or more cloud resources associated with the account.

Infrastructure-as-a-Service (“IaaS”) is a type of cloud computing service where the CSP provides infrastructure that can be used by customers to build their own customizable networks and deploy customer resources. The customer's resources and networks are thus hosted in a distributed environment by infrastructure provided by the CSP. This is different from traditional computing, where the customer's resources and networks are hosted by infrastructure provided by the customer.

The physical resources and infrastructure provided by the CSP may form a physical network, which is also referred to as a substrate network or an underlay network. Virtualization software may be executed by these physical resources to provide a virtualized distributed environment. The virtualization creates an overlay network (also known as a software-based network, a software-defined network, or a virtual network) over the physical network. A given physical network can support one or multiple overlay networks.

Customers can build their own virtual networks using compute, memory, and networking resources provided by the CSP. One or more customer resources or workloads, such as compute instances, can be deployed on these virtual networks. For example, a customer can use resources provided by the CSP to build one or multiple customizable and private virtual network(s) referred to as virtual cloud networks (“VCNs”). A customer can deploy one or more customer resources, such as compute instances, on a customer VCN. Compute instances can take the form of virtual machines, bare metal instances, and the like.

The cloud resources or infrastructure provided by a CSP may be physically hosted in one or more datacenters. Each datacenter can include various types of resources including compute, memory, and networking resources. In certain embodiments, the datacenters may be organized and hosted in realms, regions, and availability domains. A region is typically a localized geographic area that contains one or more datacenters. Regions are generally independent of each other and can be separated by vast distances, for example, across countries or even continents. For example, a first region may be in Australia, another one in Japan, yet another one in India, and the like. CSP-provided resources are divided among regions such that each region has its own independent subset of resources. Each region may provide a set of core infrastructure services and resources, such as, compute resources (e.g., bare metal servers, virtual machine, containers and related infrastructure, etc.); storage resources (e.g., block volume storage, file storage, object storage, archive storage); networking resources (e.g., VCNs, load balancing resources, connections to on-premise networks), database resources; edge networking resources (e.g., DNS); and access management and monitoring resources, and others. Each region generally has multiple paths connecting it to other regions in the realm.

Generally, resources for a customer are deployed in a region (i.e., deployed on infrastructure associated with that region) where the customer is located and where it is most heavily used. Resources may be deployed in different regions for various reasons, such as redundancy to mitigate the risk of region-wide events such as large weather systems or earthquakes, to meet varying requirements for legal jurisdictions, tax domains, and other business or social criteria, and the like. For a customer with associated users in multiple different geographical locations, the resources used for providing services to the customer may be placed in datacenters in different regions. The datacenters within a region can be further organized and subdivided into availability domains (“ADs”). An availability domain may correspond to one or more datacenters located within a region. A region can be composed of one or more availability domains.

In certain embodiments, regions are grouped into realms. A realm is a logical collection of one or more regions. Realms are isolated from each other and do not share any data. Accordingly, a datacenter in one realm does not communicate with a datacenter in another realm. Regions in the same realm may communicate with each other, but regions in different realms cannot. A customer's tenancy or account typically exists in a single realm and can be spread across one or more regions that belong to that realm. Some customers can have accounts or tenancies in multiple realms.

A CSP can provide multiple realms, each realm catering to a particular set of customers or users. For example, a commercial realm may be provided for commercial customers. As another example, country-specific realms may be provided for catering to customers or users associated with customers within specific countries. As yet another example, a government realm may be provided for a government, and the like. For example, the government realm may be catered for a specific government and may have a heightened level of security than a commercial realm.

CSP customers may have a number of tenancies. A tenancy can be an account allocated to the CSP customer that includes, in one example, a CSP customer's dedicated, logically isolated environment in a particular CSP context. Various CSP infrastructure such as compute, storage, networking, and databases can be managed at the tenancy level. Additionally administrative controls such as identity management, access policies, billing, resource organization (e.g., compartments), and so on may be managed at the tenancy level. Typically, a tenancy is associated with a single realm, ensuring compliance and isolation across geographic or regulatory boundaries. When a customer subscribes to a cloud service provided by a CSP, for example, an IaaS service, resources from CSP-provided resources in one or more datacenters are provisioned for the customer and associated with the customer's tenancy. The customer can use these provisioned resources to build private customer networks (e.g., VCNs) and deploy resources (e.g., customer applications and workloads) on these networks.

As mentioned above, tracking the usage of such resources between different datacenters and regions is a formidable challenge. The challenge is made even more complicated when a customer uses resources spread across multiple realms since the realms are isolated from each other and cannot communicate with each other. In many such use cases, a customer may sign a single agreement (e.g., an SLA) with the CSP that controls and applies to resources used by the customer across multiple datacenters, regions, and even realms. The SLA may identify levels or tiers with respect to the amounts or quantities of resources used, the associated pricing levels, and the like. For the CSP, managing the usage of resources for a customer in light of a customer SLA presents several technical challenges.

For example, consider a CSP customer with a number of tenancies. In such circumstances, the CSP can use various approaches for tracking or valuating usage of resources for the customer. In some existing approaches, resource usage for a CSP customers can be tracked by as resources are consumed, without any pre-arranged commitment. Some other existing approaches require CSP customers to commit to a certain amount of resource usage ahead of time for a given period of time. The CSP then allocates resources in accordance with such commitments. The resource commitments can then be debited, at the customer or tenancy level, as resources are consumed. This existing approach is however very static in nature and places an upper bound on resource consumption for the given period of time. In real world scenarios, resource commitments are rarely straightforward. For example, resource commitments may involve tiered thresholds of usage that vary among tenancies, network subdivisions, resources, applications, and so on. Existing approaches for tracking resource usage lack methods for communicating information about computing resource usage that can change under various circumstances and vary across logical entities such as tenancies, network subdivisions, and resources.

As described above, networks may be subdivided to support various distributed applications hosted by a CSP. In one approach, networks can be grouped by the CSP into “realms” which may each include a number of regions hosting regionally disparate datacenters that provide resources accessible to customers of the CSP. Realms can be configured to be isolated from one another and/or from other networks, which may be a critical requirement for some applications involving sensitive data, national security, and so on. Customers of the CSP can organize distributed applications, groups of applications, or other allocations of resources using tenancies, each of which may be associated with a particular realm. Tenancies, for example, can provide logical boundaries for managing resources, identities, access controls, network configurations, and other elements of the CSP's infrastructure.

CSPs have an interest in tracking the usage of resources by customers. For example, resource usage may be tracked for capacity planning, security monitoring, compliance enforcement, infrastructure allocation, billing, or other purposes. Resources, as used herein, can refer generally to computing, storage, networking, and related services provisioned and managed within the CSP's infrastructure. Resource usage can be tracked using various measurable quantities. For instance, such measurable quantities may include CPU and memory usage, storage consumption, network bandwidth, request rates, and application programming interface (“API”) call frequencies.

Resource usage can likewise be valuated. For example, the measurable quantities just mentioned can be converted using suitable conversion techniques into normalized or standardized measures of usages (e.g., virtual CPU-hours), credit consumption, currency, or other financial and operational metrics relevant to billing, budgeting, and resource optimization. Existing approaches for tracking and valuing resource usage at the realm level may involve valuating usage in each respective realm using usage value parameters to compute a value that is related to resource consumption in the realm. The usage value parameters for each realm can be stored locally to each realm by storage systems associated with usage valuation systems. After resource valuation is performed by a component in a realm (e.g., periodically or upon request), the valuated usage can be output as a value to a dedicated management realm for further processing, the management realm itself including a number of datacenters for this purpose.

Usage value parameters are not static and may vary according to different circumstances, typically according to CSP subscriptions for each customer. For example, usage value parameters can vary based on the amount, duration, or nature of the usage associated with particular resources according to the particular details of a CSP subscription. For instance, usage value parameters may be dynamically determined using a tiered usage schedule in which the usage value parameters for each respective realm may change after certain usage thresholds are satisfied. In these and other scenarios, the updated usage value parameters can be output to the usage valuation systems of each respective realm for local caching or storage in support of valuation operations.

Tracking resource usage for datacenters across realms presents several technical challenges. For example, usage limits may be allocated to a customer that may have applicability across multiple tenancies and/or multiple realms. For instance, a CSP may grant an overall usage limit for certain resources to a customer that is agnostic to which realms execute the applications that ultimately consume the resources. Moreover, the usage value parameters may vary among resources, tenancies, and/or realms according to the details of the customer’s subscription. Consequently, the usage value parameters for a particular resource, tenancy, and realm may be dependent on the resource consumption in another realm, from which it is isolated by design. Further complicating the maintenance of up to date usage value parameters among geographically distributed datacenters constituting the realms is that each realm may lack visibility of the overall usage limit for the customer, the consumption thereof, or information about how usage value parameters should change in any event. Coordination of changing usage value parameters between or among realms thus presents a formidable technical challenge.

To address these difficulties, systems and methods for parallel processing of resource usage computations across realms are disclosed. The disclosed techniques enable independent, parallelized valuation of resource usage by datacenters in isolated realms, mediated by a management realm. In an illustrative example provided to introduce certain concepts, consider a customer with isolated applications executing and using resources two realms, realm A and realm B, operating in parallel, each realm including a number of regionally distributed datacenters in one or more regions. For simplicity, assume that the customer has configured a single tenancy in each of realms A and B and that a single resource is in use by the customer’s applications. In this context, parallelized operations refer generally to operations occurring independently in realms A and B as well as sending data from the management realm to realms A and B simultaneously, whether the data is the same for both realms or different.

The realms are each communicatively coupled with the management realm. In this example, a computing system in the management realm receives data from a datacenter in realm A. The received data identifies a value computed in realm A associated with usage of a resource by the tenancy of the customer associated with realm A for some period of time. The computed value is computed in realm A using usage value parameters associated with the tenancy for realm A. In parallel, the computing system also receives data from a datacenter in realm B. Now, the received data identifies a value computed in realm B associated with usage of another resource by the tenancy of the customer that is associated with realm B, also for some period of time. The computed value is computed in realm B using usage value parameters associated with the tenancy for realm B.

The received values may be, for example, valuated usages of resources having units of CPU consumption, memory consumption, currency, electrical energy consumed, and so on. The received values may be determined using various computation techniques and the usage value parameters for the respective realms. For instance, realm A may host a usage tracking system that monitors the consumption of resources by applications executing in the customer’s tenancy. A usage valuation system, also hosted in realm A, can apply a computation technique that uses the current usage value parameters for the customer’s tenancy in realm A to compute the valuated usage. A similar process can proceed in parallel in realm B to compute the valuated usage.

The computing system in the management realm then determines, based at least one of the received values, that different usage value parameters now apply for the first customer instead of the usage value parameters previously used by realms A and B, which may differ between realm A and B. For example, the customer may have a CSP subscription that involves tiers or thresholds for resource usage, which when exceeded cause updated usage value parameters to become effective. The computing system can then communicate data, in parallel, identifying a new usage value parameters to the sending datacenter of realm A and data identifying another new usage value parameters to the sending datacenter in realm B. Usage valuation in realms A and B can then proceed as described above, except now based on the updated usage value parameters. Thus, realms A and B can operate independently, in parallel, alleviated from any need to communicate to coordinate or synchronize updated usage value parameters.

Note that while this example involved usage parameters for a single resource consumed by the customer’s tenancy in each respective realm, usage value parameters can vary at any level of granularity including between realms, tenancies, and individual resources. In real-world scenarios, complex, distributed applications will have tens, hundreds, or even thousands of usage value parameters that apply at any given moment and are furthermore in a continuous state of flux.

The techniques of the present disclosure constitute a significant improvement to the technical field of network operations and cloud computing resource usage tracking and valuation. In particular, as described above, existing approaches are inadequate for cloud computing resource usage tracking and valuation, particularly under varying degrees of physical and logical network isolation. Where the usage value parameters vary based on the amount of usage (e.g., due to tiered subscription schedules), the usage value parameters must be updated in each of the realms generating the usage during the valuation process. For example, where a customer has a CSP subscription that is activated in more than one isolated realm, usage valuation across the various isolated realms must be continuously synchronized. Existing approaches lack the capability to track valuated usage across a CSP customer’s applications that may straddle realms, tenancies, regions, datacenters, resources, and more, to update the usage value parameters that vary among the same, and to continuously push out updated usage value parameters to the isolated realms as data about valuated usage is received, resulting in fragmented and incomplete valuation processes for existing CSPs as well as inconsistencies in resource usage tracking. Parallel processing of resource usage computations across realms, as disclosed herein, is also more efficient than existing approaches, significantly reducing the amount of network traffic and computational resources needed for accurate usage valuation across realms. For instance, some existing approaches use a “polling” approach that involves continuously broadcasting usage value parameters even when they has been no update, needlessly adding to network congestion.

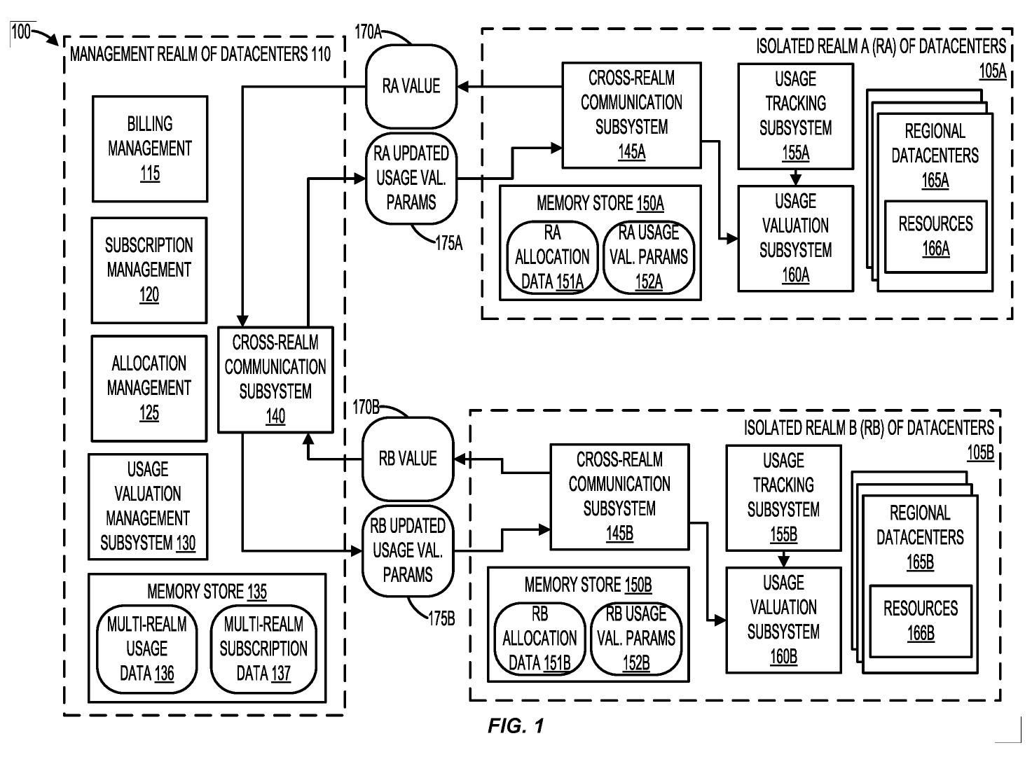

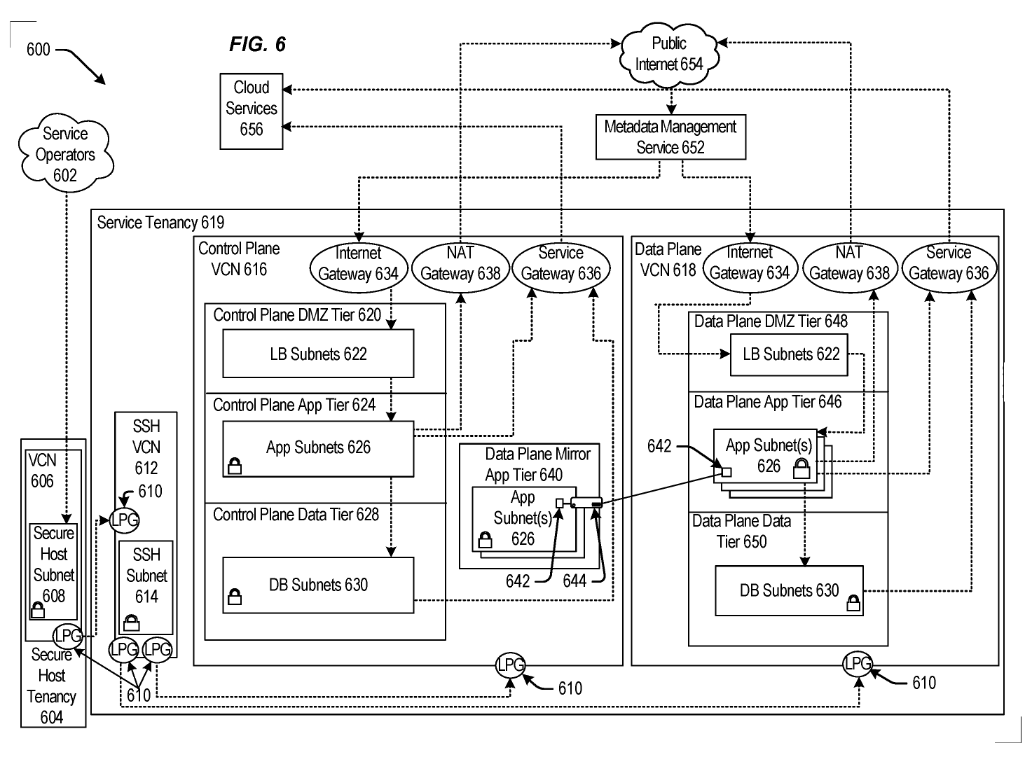

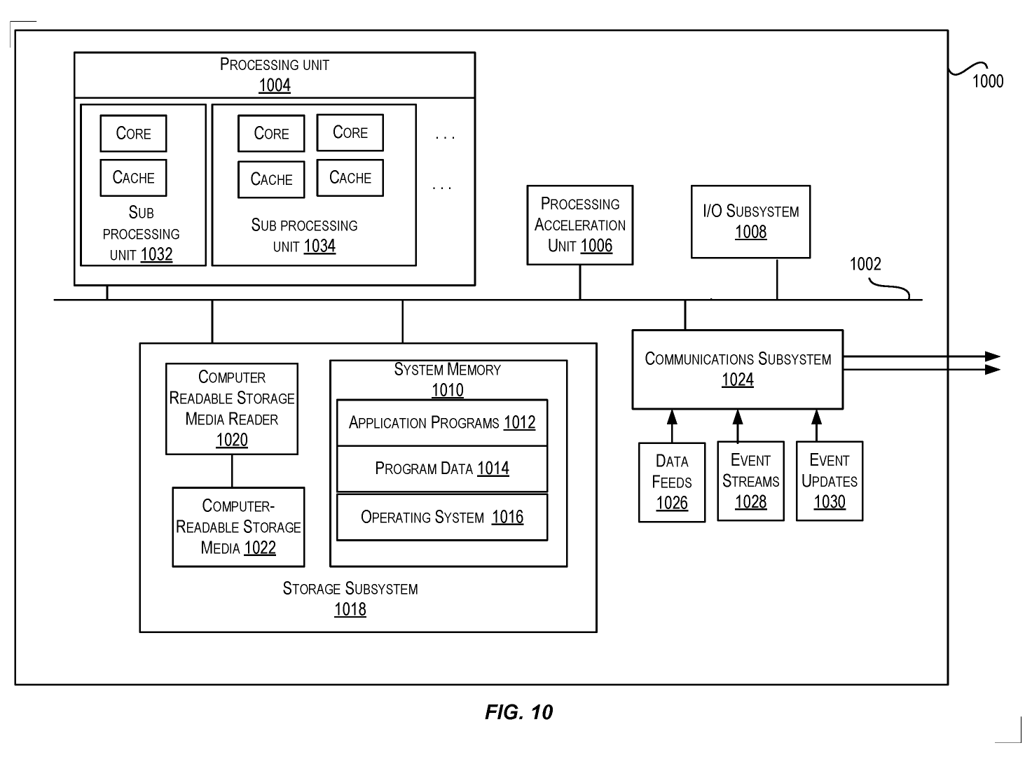

FIGS. 1-5 and the accompanying description below describe examples and embodiments related to the improved techniques described in this disclosure. FIGS. 6-9 depict examples of architectures for implementing cloud infrastructures for providing one or more cloud services, where the infrastructures may incorporate teachings described herein. FIG. 10 depicts a block diagram illustrating an example computer system or device according to at least one embodiment. One or more multiple of such computer systems may be used to perform processing and provide the functionalities described in this disclosure.

### Parallel Processing of Resource Usage Computations Across Realms

FIG. 1 depicts a system 100 implementing parallel processing of resource usage computations across realms, according to some examples of the present disclosure. System 100 depicts various components hosted by cloud service providers (“CSPs”) as part of a cloud service provider infrastructure (“CSPI”) and provided as a service to customers, a paradigm sometimes referred to as infrastructure as a service (“IaaS”). The CSPI may include a large, networked collection of scalable computing resources and services that are provided to customers on-demand for various computing tasks. The CSPI may be used for a large variety of general-purpose and specialized cloud computing tasks such as web hosting, data analytics, machine learning services, storage, application development, operational and security monitoring, among many others.

As mentioned above, elements of the CSPI can be physically and/or logically subdivided in accordance with the requirements of certain applications, such as privacy or security concerns. System 100 depicts one such subdivision, referred to herein as a “realm,” although other terms may be used in various contexts. A realm can be a logically or physically isolated environment within a CSPI that consists of multiple datacenters contained in one or more geographic regions. Realms can include resources grouped based on security, regulatory, operational requirements, or other factors. Realms can be configured to prevent direct access between certain proscribed environments, ensuring strict isolation for workloads, data, and network traffic. For example, realms may be isolated physically and/or topologically from other realms.

System 100 includes a management realm of datacenters 110 (hereinafter “management realm”) and two isolated realms, isolated realm A of datacenters 105A (hereinafter “realm A”) and isolated realm B of datacenters 105B (hereinafter “realm B” and collectively “realms”). The management realm 110 includes components for parallel processing of resource usage computations across realms. The components of the management realm 110 can be operated by the CSP and generally do not include components accessible by CSP customers. In contrast, the realms 105A, 105B include regional datacenters 165A, 165B which host resources 166A, 166B that are provided to customers as cloud computing or infrastructure services. For a given realm of the realms 105A, 105B, the regional datacenters 165A, 165B may be geographically distributed among one or more geographic regions located at any suitable location. The resources 166A, 166B may include any resources provided as services by the CSP including examples such as compute instances, virtual machines, storage volumes, databases, load balancers, networking components, and so on.

In general, both the management realm 110 and the realms 105A, 105B can include any combination of components including hardware, software, virtual machines, networking components, and so on, including components that are provided or offered by the CSPI 105 as well as components external to the CSPI. For instance, the management realm 110 or realms 105A, 105B may include user client devices that are connected to the CSPI over a network for configuration by administrators or consuming services by end users.

Communication among the management realms 110 and the realms 105A, 105B is effected using a network of parallelized cross-realm communication subsystems. The management realm 110 includes cross-realm communication subsystem 140 which sends and receives data from realm A 105A and realm B 105B, respectively. Importantly, realm A 105A and realm B 105B are isolated and cannot pass data between them. Consequently, information about usage in one isolated realm is effectively passed to another isolated realm via the cross-realm communication subsystem 140 acting as a mediator. Each of the realms 105A, 105B in turn includes its own cross-realm communication subsystem 145A, 145B that sends and receives information about usage and usage valuation in that respective realm to and from the cross-realm communication subsystem 140. In various examples, the cross-realm communication subsystems 140, 145A, 145B may use any suitable method for implementing cross-realm resource management including messaging buses, streaming services, file transfer services, and so on.

In this example system 100, the management realm 110 includes a usage valuation management subsystem 130 that can receive data from a datacenter in a realm via the cross-realm communication subsystem 140. For example, realm A 105A can communicate value 170A to the management realm 110 by, for example, sending a file including the data from the cross-realm communication subsystem 145A to the cross-realm communication subsystem 140. The data (e.g., the file) can identify the value 170A. The value 170A may be, for example, valuated usage of one of the resources 166A computed in realm A 105A by the usage valuation subsystem 160A. To compute the value 170A, the usage tracking subsystem 155A can monitor the usage of the various resources 166A by the tenancy of the customer associated with realm A 105A. For example, the usage tracking subsystem 155A can monitor quantities such as compute instance uptime, storage consumption, network bandwidth utilization, or API request rates to determine resource usage. The usage valuation subsystem 160A then computes the value 170A based on the determined usage and the locally stored usage value parameters 152A.

The usage value parameters 152A may be locally stored in memory store 150A, which can be any suitable storage system including volatile memory, an in-memory cache or database, conventional database, filesystem, and so on. For instance, the memory store 150A may be an in-memory key-value store that can be read from and written to quickly but is also synchronized to a local filesystem for redundancy in the event of system or network outages.

The value 170A may be a valuated usage computed based on a usage for a resource or resources determined by the usage tracking subsystem 155A. In a simple example, the usage value parameters 152A may include a conversion factor that can be multiplied by measures of usage to determine a valuated usage. For instance, the usage value parameters 152A may include normalized usage, credits, or cost per virtual CPU-hour, gigabyte of storage used, gigabyte of data transferred, and so on. Various computational techniques can be applied to determine the value 170A. In a more complex example, usage may be determined based on multiple weighted factors, such as compute load, storage access frequency, network traffic volume, etc. The determined usage could be valuated by integrating a weighted sum of resource usage metrics over a specified time period.

A similar process can be carried in in realm B 105B, in parallel with the process described above with respect to realm A 105A. Realm B 105B can communicate value 170B to the management realm 110 by sending data from the cross-realm communication subsystem 145B to the cross-realm communication subsystem 140. The data can identify the value 170B, which may include valuated usage of one or more of the resources 166B computed in realm B 105B by the usage valuation subsystem 160B based on usage value parameters 152B obtained by querying memory store 150B and usage information obtained from usage tracking subsystem 155B.

Upon receiving the values 170A, 170B from realms 105A, 105B in parallel, the cross-realm communication subsystem 140 can determine that the values 170A, 170B are both associated with a particular customer. For example, value 170A may be associated with a tenancy of a particular customer associated with realm 105A and value 170B may be associated with another tenancy of the same customer in associated with realm B 105B. The cross-realm communication subsystem 140 can accordingly dispatch the values 170A, 170B to the usage valuation management subsystem 130 to cause various evaluations relating to the first customer’s aggregate usage, subscription, commitments, and so on.

For example, the usage valuation management subsystem 130 can determine, based on at least one of the values 170A, 170B, that different usage value parameters apply for the customer based on some threshold being exceeded or other criteria being satisfied, rather than one or both of the usage value parameters 152A, 152B. For instance, the values 170A. 170B, taken together, can be used to determine a combined value. The combined value may represent, for example, the aggregate usage for a certain period of time, of a particular resource across all realms included in the customer’s CSP subscription.

The usage valuation management subsystem 130 can determine new usage value parameters using multi-realm subscription data 137 obtained by querying the memory store 135. Like the memory stores of the isolated realms, the memory store 135 can be any suitable storage system including volatile memory, an in-memory cache or database, conventional database, filesystem, and so on. The multi-realm subscription data 137 can include information for computing new usage value parameters for particular customers, tenancies, realms, and/or resources as well as how such information changes when various criteria are satisfied (e.g., when a particular tier of usage is exceeded or when an overall customer usage or valuated usage commitment has been used up for period of time). The updated usage value parameters 175A can then be communicated to the realm 105A via the cross-realm communication subsystem 140. For example, the cross-realm communication subsystem 140 may send data including the updated usage value parameters 175A to the cross-realm communication subsystem 145A. In parallel, a similar process can be used to generate and send updated usage value parameters 175B to realm B 105B.

The memory store 135 also persists multi-realm usage data 136. The multi-realm usage data 136 may include commitment and balance values for a given customer. A commitment value can refer generally to a predetermined amount of usage or valuated usage associated with a particular resource or collection resources, for a specified customer, tenancy, realm, and/or resource. The balance value is based on the commitment value and may be, for example, the amount of a given commitment that is remaining or unused for a certain period of time or other bound. The multi-realm usage data 136 may also include a record of values 170A, 170B and usage value parameters 175A, 175B, 152A, 152B managed by the usage valuation management subsystem 130.

The management realm 110 includes several other components that can perform functions to support parallel processing of resource usage computations across realms. For example, the management realm 110 includes a subscription management component 120 and an associated billing management component 115. The subscription management component 120 can be used for receiving information about customer CSP subscriptions from external subscription management systems (not shown) and generating information that can be used by the usage valuation management subsystem 130 for generating usage value parameters according to received usage or valuated usage information. For example, a customer CSP subscription may include information such as commitment values, tiered valuation schedules or thresholds, valuation schedules covering various possible contingencies (e.g., valuation schedules for exhausted commitment values), and so on. The billing management component 115 can be used for functions such as invoicing, receiving of payments, and initiating subscriptions by sending an appropriate message to the subscription management component 120.

In one example, the subscription information managed by the subscription management component 120 is used to determine a commitment value from which a balance value is then maintained by the allocation management component 125 and/or the usage valuation management subsystem 130. For example, the balance value can initially (i.e., at the start of a predetermined period or cycle) be based on the commitment balance and then updated as parallel valuated usage data is received from the realms 105A, 105B. In some examples, the allocation management component 125 may receive reservation requests for particular resources. For instance, a component of the realm 105A such as the usage tracking subsystem 155A can determine an estimated usage of a resource for a period of time and request an allocation of the remaining balance before the resource is actually used. In other words, the realm 105A can be “loaned” a portion of the balance value for a customer. If the reservation request is granted by the allocation management component 125, the realm 105A can then maintain a local balance value such as allocation data 151A in the memory store 150A. The local allocation data 151A can be used to track or limit valuated usage locally, within the realm 105A, rather than coordinating such usage with the management realm 110 for the period of time, which can be more efficient, conserve network bandwidth, and may be more secure. When the reservation request is granted, the allocation management component 125 can update the balance value based on the reservation request (e.g., by debiting the balance value for the associated customer). A similar process may occur in other realms such as realm 105B, including locally stored allocation data 151B in memory store 150B.

In some examples, subscription information managed by the subscription management component 120 may be communicated to the realms 105A, 105B in parallel. For example, upon system initialization, system restarts or restores, upon update (e.g., the subscription information is changed), or periodically, the subscription information can be communicated to the realm 105A. In cases where there realm 105A is maintaining a local balance as described in the previous paragraph, updating of the subscription information in the realm 105A can cause deletion of any locally stored balance value such as the allocation data 151A.

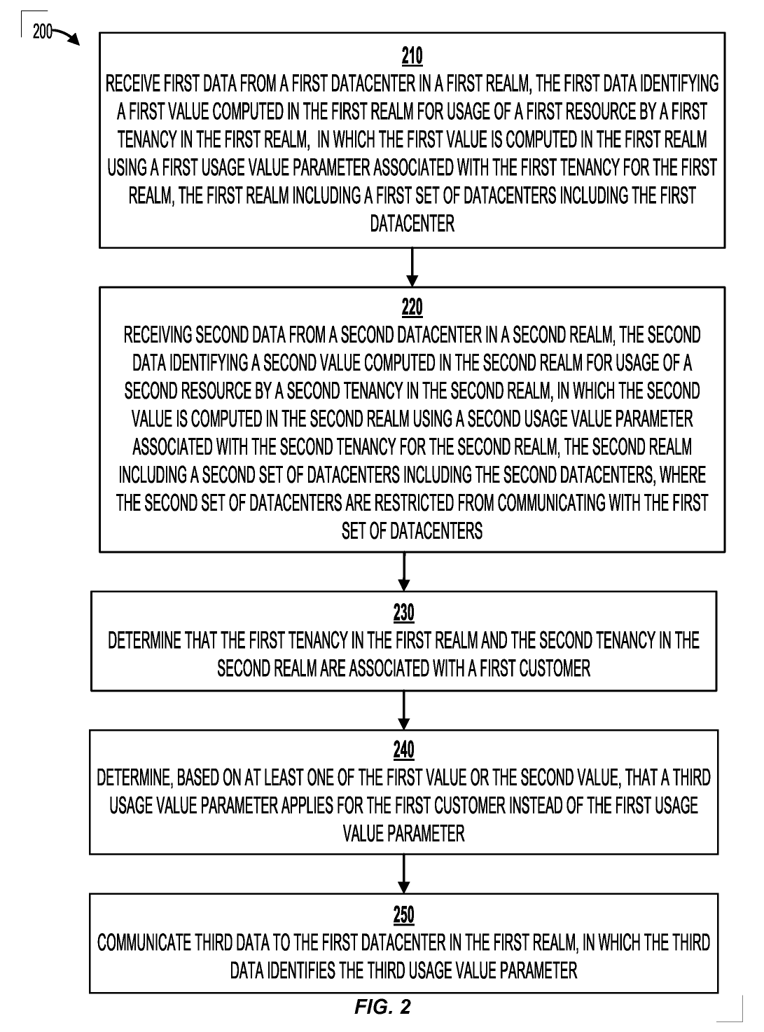

FIG. 2 depicts a simplified flowchart showing a method for parallel processing of resource usage computations across realms, according to some examples of the present disclosure. The method 200 depicted in FIG. 2 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method 200 presented in FIG. 2 and described below is intended to be illustrative and non-limiting. Although FIG. 2 depicts the various processing steps occurring in a particular sequence or order, this is not intended to be limiting. In certain alternative embodiments, the processing may be performed in some different order, or some steps may also be performed in parallel.

At block 210, a computing system such as the usage valuation management subsystem 130 of FIG. 1 receives first data from a first datacenter in a first realm, the first data identifying a first value computed in the first realm (e.g., realm A 105A) for usage of a first resource by a first tenancy in the first realm, in which the first value is computed in the first realm using first usage value parameters associated with the first tenancy for the first realm, the first realm comprising a first set of datacenters including the first datacenter. For example, the first resource may be one or more compute nodes, storage systems, virtual machines, and so on. A usage tracking mechanism such as usage tracking subsystem 155A can measure the consumption of the first resource and a component such as the usage valuation subsystem 160A can determine the first value using the measured usage and the usage value parameters 152A. The first value may be, for example, valuated usage of the first resource such as a total compute time, an amount of storage space, a volume of network traffic, or a currency or credit valuation thereof.

At block 220, the computing system receives second data from a second datacenter in a second realm, the second data identifying a second value computed in the second realm for usage of a second resource by a second tenancy in the second realm, in which the second value is computed in the second realm using second usage value parameters associated with the second tenancy for the second realm, the second realm comprising a second set of datacenters including the second datacenters, where the second set of datacenters are restricted from communicating with the first set of datacenters. Block 220 can proceed substantially as block 210, except that the second data is received in parallel with the operations of block 210 from a second isolated realm (e.g., realm B 105B) that is logically and/or topologically isolated from the first realm.

The first value and the second value can be determined for a first time period. For example, the first and second realms can sent data to the computing system periodically, the period being the first time period. In some examples, the first and second realms can include timekeeping subsystems that are synchronized (e.g., using the network time protocol (“NTP”)). The first and second realms can communicate the values upon the lapse of a predetermined time period such as one minute, one hour, one day, and so on. Alternatively, the first and second value can be sent after the first period time as measured locally in each realm. In some other examples, the first and second realms can send the first and second values independently, upon satisfaction of a condition such as a threshold amount of usage or usage valuation.

At block 230, the computing system determines that the first tenancy in the first realm and the second tenancy in the second realm are associated with a first customer. For example, the first customer may be associated with a subscription provided by a CSP. For subscriptions that are associated with more than isolated realm (e.g., realms 105A and 105B of FIG. 1), certain quantities and actions such as resource usage, usage valuations, balance values, commitment values, and so on must be synchronized among the isolated realms for correctness, despite the physical and/or logical possibility of direct communication between isolated realms.

The subscription of the first customer may include a commitment value. The commitment value may be, for example, a predetermined quantity of valuated usage for a particular resource or aggregate collection of resources. For instance, the commitment value may be a predetermined amount of compute processing time, storage capacity, or data transfer volume. In some examples, the commitment value may be expressed in monetary terms as a fixed spending commitment or usage credits.

The commitment value may be applicable for a specified period of time such as a month or year. During the specified period of time, a balance value can reflect the portion of the commitment value that has not yet been used or consumed during the specified period of time. In the simplest case, the commitment value can be debited when information about valuated usage is received by the computing system. In another example, the balance value may be reduced based according to weighted usage valuations that can account for different resource types or usage scenarios. For instance, compute usage may be weighted more heavily than storage, leading to different deduction rates from the remaining balance. In the case of example method 200, the balance value can be updated using the first value and the second value by computing a combined value. The first and second values can be added, combined using a weighted combination strategy, added to an aggregate computation such as an integration or histogram, or other suitable combination approach.

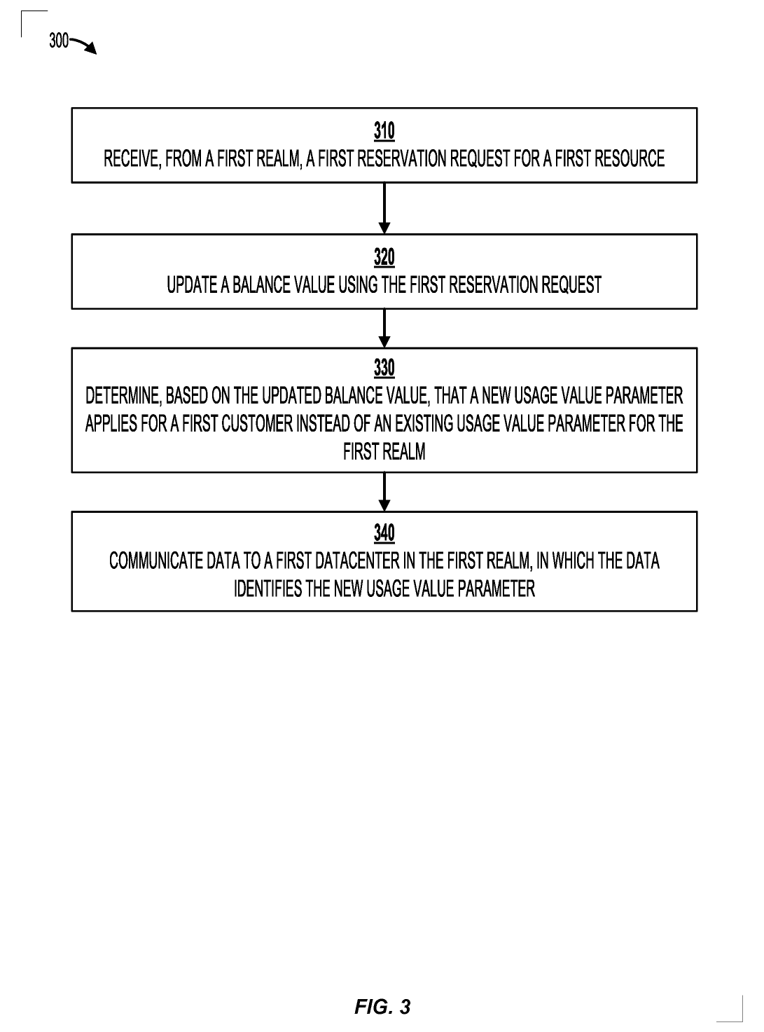

In some examples, the subscription information may be communicated to the first realm and the second realm. Upon receipt of the subscription information, the first and second realms may be caused to delete locally stored balance values. The locally stored balance values may be used in scenarios such as customers with only tenancy associated with one realm or when balance values are locally cached for efficiency, as described below with respect to FIG. 3.

At block 240, the computing system determines, based on at least one of the first value or the second value, that third usage value parameters apply for the first customer instead of the first usage value parameters. This determination may involve, for example, determining that the balance value, derived from the commitment value, satisfies a particular threshold of one or more thresholds associated with the subscription for the first customer. In this example, the current magnitude of the balance value is compared with a threshold value. In another example, satisfaction of a threshold may be determined by first determining total usage values for the first and second resources using the first and second values, respectively. Then, the computed total usage values can be compared with a threshold value. In contrast to the previous example, this illustrates a determination that the third usage value parameters apply in cases where there is no changing balance value (e.g., an “a la carte” subscription model).

For example, if the first customer is associated with a subscription that specifies a tiered schedule for valuating usage, then determining that the third usage value parameters apply may involve determining that either of the first value or the second value has resulted in a transition to another usage tier. For instance, usage valuation may be performed using the first usage value parameters for a first usage band for the first resource (e.g., the first 100 TB of storage or the first $1M of consumption of a commitment value). Once the first usage band is exceeded, a second usage band may be used (e.g., the next 200 TB or storage or the next $5M of consumption of a commitment value), the second usage band having the associated third usage value parameters.

In some examples, a combined value can be generated based on the first value and the second value. For example, the first value and the second value can be added, composed, weighted, or combined using any other suitable computation technique. The combined value can be used to determine that another usage value parameters apply for a particular context. For example, the combined value may be used in lieu of either of the first or the second values in the example of the previous paragraph.

In some examples, the first value, the second value, or the combined value can likewise be used to determine that different usage value parameters apply for other realms, such as the second realm. In this example, the first and second usage value parameters are different. For instance, the first usage value parameters may apply to the first tenancy of the first customer and the first realm, while the second usage value parameters may apply to the second tenancy of the second customer and the second realm. The usage value parameters for different combinations of customer, realm, tenancy, or resource may vary. In some examples, they may also be the same. For example, the first or second value may cause the usage value parameters for all realms to change to new usage value parameters that is the same for all realms.

At block 250, the computing system communicates third data to the first datacenter in the first realm, wherein the third data identifies the third usage value parameters. For example, the third data can be communicated via the cross-realm communication subsystems 140, 145A. The third data may be received by the usage valuation subsystem 160A. The usage valuation subsystem 160A can cause the existing usage value parameters 152A to be purged from the memory store 150A and replaced with the third usage value parameters (e.g., updated usage value parameters 175A). The third usage value parameters can then be used for valuating usage as described in block 210.

FIG. 3 depicts a simplified flowchart showing a method for providing reservation requests for parallel processing of resource usage computations across realms, according to some examples of the present disclosure. The method 300 depicted in FIG. 3 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method 300 presented in FIG. 3 and described below is intended to be illustrative and non-limiting. Although FIG. 3 depicts the various processing steps occurring in a particular sequence or order, this is not intended to be limiting. In certain alternative embodiments, the processing may be performed in some different order, or some steps may also be performed in parallel.

At block 310, a computing system such as the allocation management component 125 of FIG. 1 receives, from a first realm, a first reservation request for a first resource. In this example, reservation requests are processed by components of the management realm 110. The first reservation request may be, for example, an estimated usage or valuated usage for the first resource. If the first resource is a collection of compute nodes, then the first reservation request may be a number of CPU-hours or valuated CPU-hours (e.g., credits or currency). In some examples, the first realm may use a locally stored or cached balance value equal to the value of the first reservation request (e.g., allocation data 151A). The first reservation request can be thought of in analogy to a request for “loan” from the balance value to the requesting realm.

At block 320, the computing system updates a balance value using the first reservation request. For example, the balance value may reflect the remaining portion of a commitment value associated with a customer for a period of time. The computing system can debit the balance value using the first reservation request. Consequently, the balance value can reflect the available usage or valuated usage available for all realms in use by the associated customer.

At block 330, the computing system determines, based on the updated balance value, that new usage value parameters apply for a first customer instead of existing usage value parameters for the first realm. Block 330 can proceed substantially as block 240 described above with respect to FIG. 2. However, in this example, the updated balance value reflecting the first reservation request is used for the determination the new usage value parameters apply rather than the first or second values.

At block 340, the computing system communicates data to a first datacenter in the first realm, in which the data identifies the new usage value parameter. Block 330 can proceed substantially as block 250 described above with respect to FIG. 2.

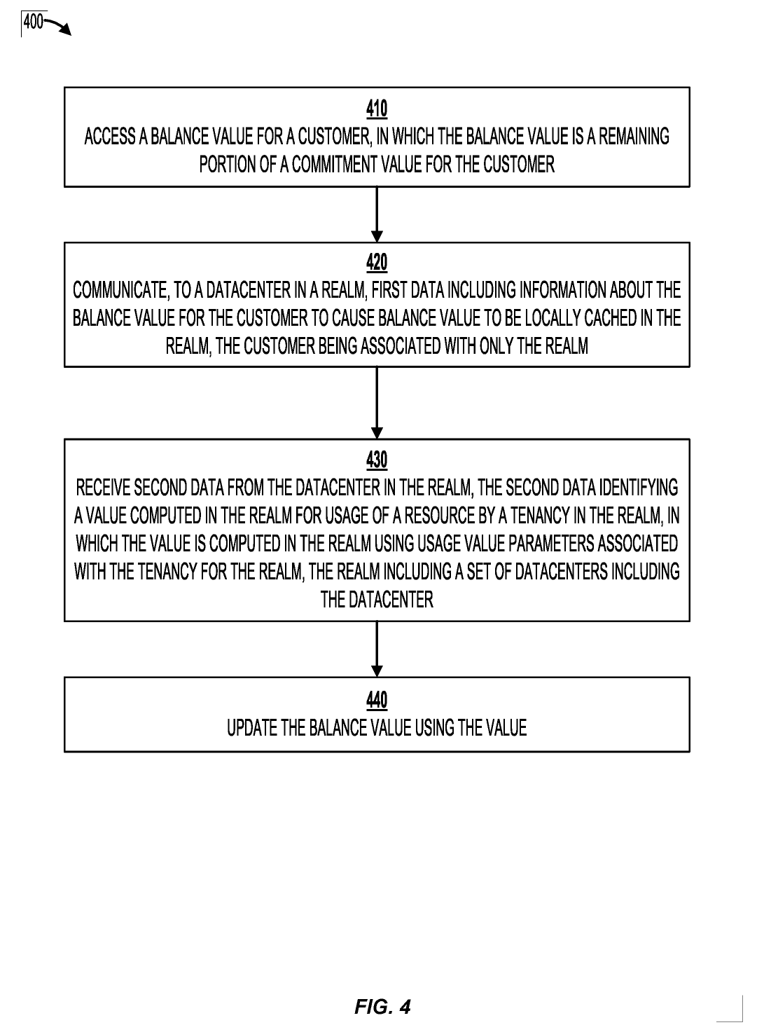

FIG. 4 depicts a simplified flowchart showing a method for single-realm datacenter resource usage management, according to some examples of the present disclosure. The method 400 depicted in FIG. 4 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method 400 presented in FIG. 4 and described below is intended to be illustrative and non-limiting. Although FIG. 4 depicts the various processing steps occurring in a particular sequence or order, this is not intended to be limiting. In certain alternative embodiments, the processing may be performed in some different order, or some steps may also be performed in parallel.

At block 410, a computing system such as the usage valuation management subsystem 130 of FIG. 1 accesses a balance value for a customer, in which the balance value is a remaining portion of a commitment value for the customer. In this example, the customer may have a CSP subscription that involves a single tenancy and a single realm. Just as with the multi-realm case, the customer may be associated with a commitment value that specifies a usage or valuated usage identified at the beginning of a period of time or other demarcation. The balance value, in this example, reflects the portion of the commitment value remaining for the demarcated period.

At block 420, the computing system communicates, to a datacenter in a realm, first data including information about the balance value for the customer to cause balance value to be locally cached in the realm, the customer being associated with only the realm. For example, for subscriptions that are associated with only one realm, such as the present example, the balance value can be stored or cached locally in a memory store (e.g., memory store 150A). Storing or caching the balance value locally can, for example, reduce the latency associated with reservation requests as well as reduce the number of cross-realm network traffic. In this case, management of usage with respect to the limits defined by the balance value can be performed using the cached balance value in realm.

At block 430, the computing system receives second data from the datacenter in the realm, the second data identifying a value computed in the realm for usage of a resource by a tenancy in the realm, in which the value is computed in the realm using usage value parameters associated with the tenancy for the realm, the realm including a set of datacenters including the datacenter. Valuated usage can still be periodically communicated to the management realm 110 for reconciliation, billing, and so on. This reflects a configuration in which, although the balance value may be locally cached in the realm, the management realm 110 includes the components that manage state for all customer and realms. The value may be, for example, valuated usage associated with the resource, substantially as described in blocks 210 and 220 above with respect to FIG. 2.

At block 440, the computing system updates the balance value using the value. As just mentioned, the management realm 110, or component therein such as the allocation management component 125, can make the appropriate adjustments to the balance value using a suitable computation technique. The updated balance value can be stored in the memory store 135 as multi-realm subscription data 137. In this example, the multi-realm subscription data 137 includes data for all realms and customers, including, as in this example, customers with only a single tenancy in a single realm.

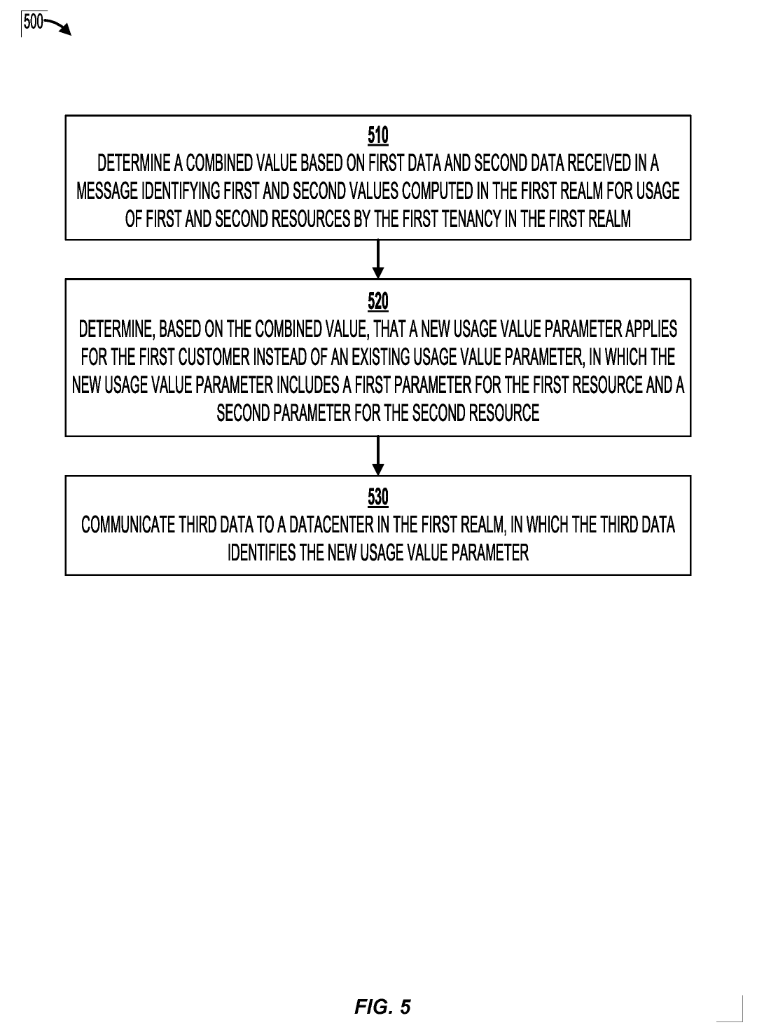

FIG. 5 depicts a simplified flowchart showing a method for providing multi-resource data for parallel processing of resource usage computations across realms, according to some examples of the present disclosure. The method 500 depicted in FIG. 5 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method 500 presented in FIG. 5 and described below is intended to be illustrative and non-limiting. Although FIG. 5 depicts the various processing steps occurring in a particular sequence or order, this is not intended to be limiting. In certain alternative embodiments, the processing may be performed in some different order, or some steps may also be performed in parallel.

Because cross-realm network communications between, for example, realm A 105A and the management realm 110, can be slow, the realm components such as the usage valuation subsystems 160A, 160B can utilize batching to reduce the amount of network traffic associated with reporting usage via the cross-realm communication subsystems 140, 145A. In one example of such a batching process, at block 510, a computing system such as the usage valuation management subsystem 130 determines a combined value based on first data and second data received in a message identifying first and second values computed in the first realm for usage of first and second resources by the first tenancy in the first realm. In this example, the message includes usage or valuated usage from the first realm for more than one resource at a time. Batching can include messages that report any number of usages or valuated usages for particular customers, realms, tenancies, resources, or any combination thereof.

At block 520, the computing system determines, based on the combined value, that a new usage value parameter applies for the first customer instead of an existing usage value parameter, in which the new usage value parameter includes a first parameter for the first resource and a second parameter for the second resource. This block can proceed substantially as described above with respect to block 240, except that the combined value is used rather than the first and second values.

At block 540, the computing system communicate third data to a datacenter in the first realm, in which the third data identifies the new usage value parameter. This block can proceed substantially as described above with respect to block 250 of FIG. 2.

While the method 500 illustrates an example in which two resources in use by the first customer are included in a batched message, other batching configurations can be used. For example, batching can be based on whether particular resources are used in more than one realm. A first type of message can include batched resource usage for resources only used in a single realm. A second type of message can include batched resource usage for resources used in multiple realms. Similarly, batches can be based on collections of usages or usage valuations for customers, CSP subscriptions, particular groupings of tenancies or realms, and so on. Selection of batching can improve efficiency and reduce network congestions, particularly in scenarios where locally cached balance values are in use.

### Example Architectures for Providing a Cloud Service

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 6 is a block diagram 600 illustrating an example pattern of an IaaS architecture, according to at least one embodiment. Service operators 602 can be communicatively coupled to a secure host tenancy 604 that can include a virtual cloud network (VCN) 606 and a secure host subnet 608. In some examples, the service operators 602 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 606 and/or the Internet.

The VCN 606 can include a local peering gateway (LPG) 610 that can be communicatively coupled to a secure shell (SSH) VCN 612 via an LPG 610 contained in the SSH VCN 612. The SSH VCN 612 can include an SSH subnet 614, and the SSH VCN 612 can be communicatively coupled to a control plane VCN 616 via the LPG 610 contained in the control plane VCN 616. Also, the SSH VCN 612 can be communicatively coupled to a data plane VCN 618 via an LPG 610. The control plane VCN 616 and the data plane VCN 618 can be contained in a service tenancy 619 that can be owned and/or operated by the IaaS provider.

The control plane VCN 616 can include a control plane demilitarized zone (DMZ) tier 620 that acts as a perimeter network (e.g., portions of a corporate network between the corporate intranet and external networks). The DMZ-based servers may have restricted responsibilities and help keep breaches contained. Additionally, the DMZ tier 620 can include one or more load balancer (LB) subnet(s) 622, a control plane app tier 624 that can include app subnet(s) 626, a control plane data tier 628 that can include database (DB) subnet(s) 630 (e.g., frontend DB subnet(s) and/or backend DB subnet(s)). The LB subnet(s) 622 contained in the control plane DMZ tier 620 can be communicatively coupled to the app subnet(s) 626 contained in the control plane app tier 624 and an Internet gateway 634 that can be contained in the control plane VCN 616, and the app subnet(s) 626 can be communicatively coupled to the DB subnet(s) 630 contained in the control plane data tier 628 and a service gateway 636 and a network address translation (NAT) gateway 638. The control plane VCN 616 can include the service gateway 636 and the NAT gateway 638.

The control plane VCN 616 can include a data plane mirror app tier 640 that can include app subnet(s) 626. The app subnet(s) 626 contained in the data plane mirror app tier 640 can include a virtual network interface controller (VNIC) 642 that can execute a compute instance 644. The compute instance 644 can communicatively couple the app subnet(s) 626 of the data plane mirror app tier 640 to app subnet(s) 626 that can be contained in a data plane app tier 646.

The data plane VCN 618 can include the data plane app tier 646, a data plane DMZ tier 648, and a data plane data tier 650. The data plane DMZ tier 648 can include LB subnet(s) 622 that can be communicatively coupled to the app subnet(s) 626 of the data plane app tier 646 and the Internet gateway 634 of the data plane VCN 618. The app subnet(s) 626 can be communicatively coupled to the service gateway 636 of the data plane VCN 618 and the NAT gateway 638 of the data plane VCN 618. The data plane data tier 650 can also include the DB subnet(s) 630 that can be communicatively coupled to the app subnet(s) 626 of the data plane app tier 646.

The Internet gateway 634 of the control plane VCN 616 and of the data plane VCN 618 can be communicatively coupled to a metadata management service 652 that can be communicatively coupled to public Internet 654. Public Internet 654 can be communicatively coupled to the NAT gateway 638 of the control plane VCN 616 and of the data plane VCN 618. The service gateway 636 of the control plane VCN 616 and of the data plane VCN 618 can be communicatively coupled to cloud services 656.

In some examples, the service gateway 636 of the control plane VCN 616 or of the data plane VCN 618 can make application programming interface (API) calls to cloud services 656 without going through public Internet 654. The API calls to cloud services 656 from the service gateway 636 can be one-way: the service gateway 636 can make API calls to cloud services 656, and cloud services 656 can send requested data to the service gateway 636. But, cloud services 656 may not initiate API calls to the service gateway 636.

In some examples, the secure host tenancy 604 can be directly connected to the service tenancy 619, which may be otherwise isolated. The secure host subnet 608 can communicate with the SSH subnet 614 through an LPG 610 that may enable two-way communication over an otherwise isolated system. Connecting the secure host subnet 608 to the SSH subnet 614 may give the secure host subnet 608 access to other entities within the service tenancy 619.

The control plane VCN 616 may allow users of the service tenancy 619 to set up or otherwise provision desired resources. Desired resources provisioned in the control plane VCN 616 may be deployed or otherwise used in the data plane VCN 618. In some examples, the control plane VCN 616 can be isolated from the data plane VCN 618, and the data plane mirror app tier 640 of the control plane VCN 616 can communicate with the data plane app tier 646 of the data plane VCN 618 via VNICs 642 that can be contained in the data plane mirror app tier 640 and the data plane app tier 646.

In some examples, users of the system, or customers, can make requests, for example create, read, update, or delete (CRUD) operations, through public Internet 654 that can communicate the requests to the metadata management service 652. The metadata management service 652 can communicate the request to the control plane VCN 616 through the Internet gateway 634. The request can be received by the LB subnet(s) 622 contained in the control plane DMZ tier 620. The LB subnet(s) 622 may determine that the request is valid, and in response to this determination, the LB subnet(s) 622 can transmit the request to app subnet(s) 626 contained in the control plane app tier 624. If the request is validated and requires a call to public Internet 654, the call to public Internet 654 may be transmitted to the NAT gateway 638 that can make the call to public Internet 654. Metadata that may be desired to be stored by the request can be stored in the DB subnet(s) 630.

In some examples, the data plane mirror app tier 640 can facilitate direct communication between the control plane VCN 616 and the data plane VCN 618. For example, changes, updates, or other suitable modifications to configuration may be desired to be applied to the resources contained in the data plane VCN 618. Via a VNIC 642, the control plane VCN 616 can directly communicate with, and can thereby execute the changes, updates, or other suitable modifications to configuration to, resources contained in the data plane VCN 618.

In some embodiments, the control plane VCN 616 and the data plane VCN 618 can be contained in the service tenancy 619. In this case, the user, or the customer, of the system may not own or operate either the control plane VCN 616 or the data plane VCN 618. Instead, the IaaS provider may own or operate the control plane VCN 616 and the data plane VCN 618, both of which may be contained in the service tenancy 619. This embodiment can enable isolation of networks that may prevent users or customers from interacting with other users’, or other customers’, resources. Also, this embodiment may allow users or customers of the system to store databases privately without needing to rely on public Internet 654, which may not have a desired level of threat prevention, for storage.

In other embodiments, the LB subnet(s) 622 contained in the control plane VCN 616 can be configured to receive a signal from the service gateway 636. In this embodiment, the control plane VCN 616 and the data plane VCN 618 may be configured to be called by a customer of the IaaS provider without calling public Internet 654. Customers of the IaaS provider may desire this embodiment since database(s) that the customers use may be controlled by the IaaS provider and may be stored on the service tenancy 619, which may be isolated from public Internet 654.

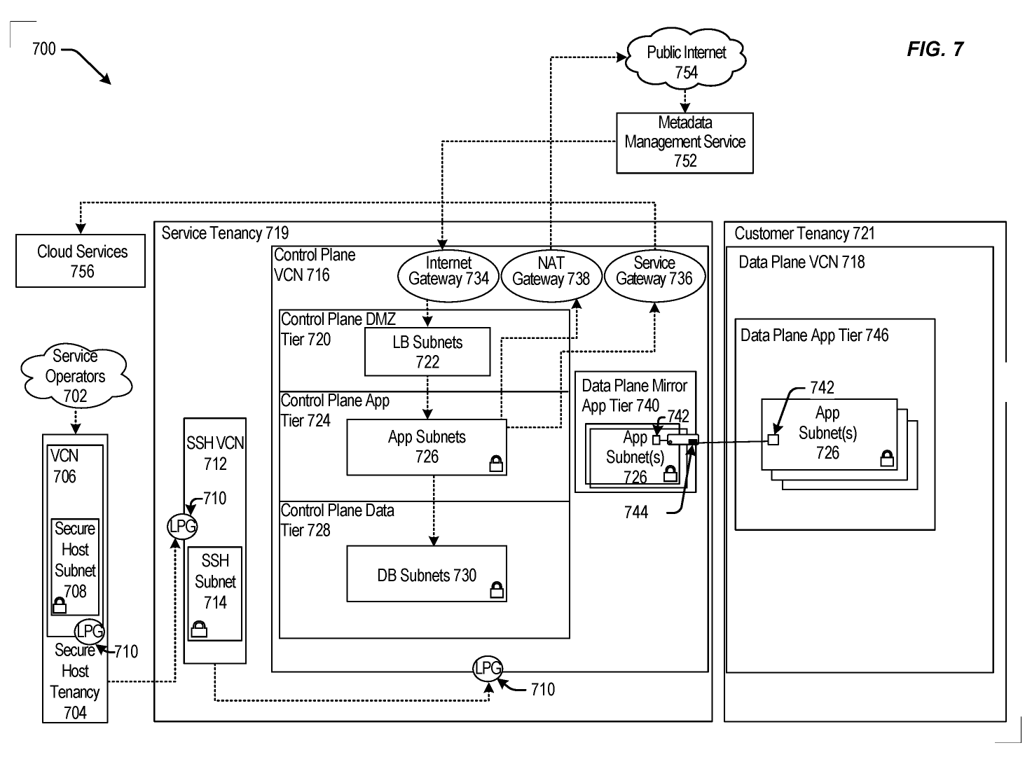

FIG. 7 is a block diagram 700 illustrating another example pattern of an IaaS architecture, according to at least one embodiment. Service operators 702 (e.g., service operators 602 of FIG. 6) can be communicatively coupled to a secure host tenancy 704 (e.g., the secure host tenancy 604 of FIG. 6) that can include a virtual cloud network (VCN) 706 (e.g., the VCN 606 of FIG. 6) and a secure host subnet 708 (e.g., the secure host subnet 608 of FIG. 6). The VCN 706 can include a local peering gateway (LPG) 710 (e.g., the LPG 610 of FIG. 6) that can be communicatively coupled to a secure shell (SSH) VCN 712 (e.g., the SSH VCN 612 of FIG. 6) via an LPG 610 contained in the SSH VCN 712. The SSH VCN 712 can include an SSH subnet 714 (e.g., the SSH subnet 614 of FIG. 6), and the SSH VCN 712 can be communicatively coupled to a control plane VCN 716 (e.g., the control plane VCN 616 of FIG. 6) via an LPG 710 contained in the control plane VCN 716. The control plane VCN 716 can be contained in a service tenancy 719 (e.g., the service tenancy 619 of FIG. 6), and the data plane VCN 718 (e.g., the data plane VCN 618 of FIG. 6) can be contained in a customer tenancy 721 that may be owned or operated by users, or customers, of the system.

The control plane VCN 716 can include a control plane DMZ tier 720 (e.g., the control plane DMZ tier 620 of FIG. 6) that can include LB subnet(s) 722 (e.g., LB subnet(s) 622 of FIG. 6), a control plane app tier 724 (e.g., the control plane app tier 624 of FIG. 6) that can include app subnet(s) 726 (e.g., app subnet(s) 626 of FIG. 6), a control plane data tier 728 (e.g., the control plane data tier 628 of FIG. 6) that can include database (DB) subnet(s) 730 (e.g., similar to DB subnet(s) 630 of FIG. 6). The LB subnet(s) 722 contained in the control plane DMZ tier 720 can be communicatively coupled to the app subnet(s) 726 contained in the control plane app tier 724 and an Internet gateway 734 (e.g., the Internet gateway 634 of FIG. 6) that can be contained in the control plane VCN 716, and the app subnet(s) 726 can be communicatively coupled to the DB subnet(s) 730 contained in the control plane data tier 728 and a service gateway 736 (e.g., the service gateway 636 of FIG. 6) and a network address translation (NAT) gateway 738 (e.g., the NAT gateway 638 of FIG. 6). The control plane VCN 716 can include the service gateway 736 and the NAT gateway 738.

The control plane VCN 716 can include a data plane mirror app tier 740 (e.g., the data plane mirror app tier 640 of FIG. 6) that can include app subnet(s) 726. The app subnet(s) 726 contained in the data plane mirror app tier 740 can include a virtual network interface controller (VNIC) 742 (e.g., the VNIC of 642) that can execute a compute instance 744 (e.g., similar to the compute instance 644 of FIG. 6). The compute instance 744 can facilitate communication between the app subnet(s) 726 of the data plane mirror app tier 740 and the app subnet(s) 726 that can be contained in a data plane app tier 746 (e.g., the data plane app tier 646 of FIG. 6) via the VNIC 742 contained in the data plane mirror app tier 740 and the VNIC 742 contained in the data plane app tier 746.

The Internet gateway 734 contained in the control plane VCN 716 can be communicatively coupled to a metadata management service 752 (e.g., the metadata management service 652 of FIG. 6) that can be communicatively coupled to public Internet 754 (e.g., public Internet 654 of FIG. 6). Public Internet 754 can be communicatively coupled to the NAT gateway 738 contained in the control plane VCN 716. The service gateway 736 contained in the control plane VCN 716 can be communicatively coupled to cloud services 756 (e.g., cloud services 656 of FIG. 6).

In some examples, the data plane VCN 718 can be contained in the customer tenancy 721. In this case, the IaaS provider may provide the control plane VCN 716 for each customer, and the IaaS provider may, for each customer, set up a unique compute instance 744 that is contained in the service tenancy 719. Each compute instance 744 may allow communication between the control plane VCN 716, contained in the service tenancy 719, and the data plane VCN 718 that is contained in the customer tenancy 721. The compute instance 744 may allow resources, that are provisioned in the control plane VCN 716 that is contained in the service tenancy 719, to be deployed or otherwise used in the data plane VCN 718 that is contained in the customer tenancy 721.

In other examples, the customer of the IaaS provider may have databases that live in the customer tenancy 721. In this example, the control plane VCN 716 can include the data plane mirror app tier 740 that can include app subnet(s) 726. The data plane mirror app tier 740 can reside in the data plane VCN 718, but the data plane mirror app tier 740 may not live in the data plane VCN 718. That is, the data plane mirror app tier 740 may have access to the customer tenancy 721, but the data plane mirror app tier 740 may not exist in the data plane VCN 718 or be owned or operated by the customer of the IaaS provider. The data plane mirror app tier 740 may be configured to make calls to the data plane VCN 718 but may not be configured to make calls to any entity contained in the control plane VCN 716. The customer may desire to deploy or otherwise use resources in the data plane VCN 718 that are provisioned in the control plane VCN 716, and the data plane mirror app tier 740 can facilitate the desired deployment, or other usage of resources, of the customer.

In some embodiments, the customer of the IaaS provider can apply filters to the data plane VCN 718. In this embodiment, the customer can determine what the data plane VCN 718 can access, and the customer may restrict access to public Internet 754 from the data plane VCN 718. The IaaS provider may not be able to apply filters or otherwise control access of the data plane VCN 718 to any outside networks or databases. Applying filters and controls by the customer onto the data plane VCN 718, contained in the customer tenancy 721, can help isolate the data plane VCN 718 from other customers and from public Internet 754.

In some embodiments, cloud services 756 can be called by the service gateway 736 to access services that may not exist on public Internet 754, on the control plane VCN 716, or on the data plane VCN 718. The connection between cloud services 756 and the control plane VCN 716 or the data plane VCN 718 may not be live or continuous. Cloud services 756 may exist on a different network owned or operated by the IaaS provider. Cloud services 756 may be configured to receive calls from the service gateway 736 and may be configured to not receive calls from public Internet 754. Some cloud services 756 may be isolated from other cloud services 756, and the control plane VCN 716 may be isolated from cloud services 756 that may not be in the same region as the control plane VCN 716. For example, the control plane VCN 716 may be located in “Region 1,” and cloud service “Deployment 6,” may be located in Region 1 and in “Region 2.” If a call to Deployment 6 is made by the service gateway 736 contained in the control plane VCN 716 located in Region 1, the call may be transmitted to Deployment 6 in Region 1. In this example, the control plane VCN 716, or Deployment 6 in Region 1, may not be communicatively coupled to, or otherwise in communication with, Deployment 6 in Region 2.

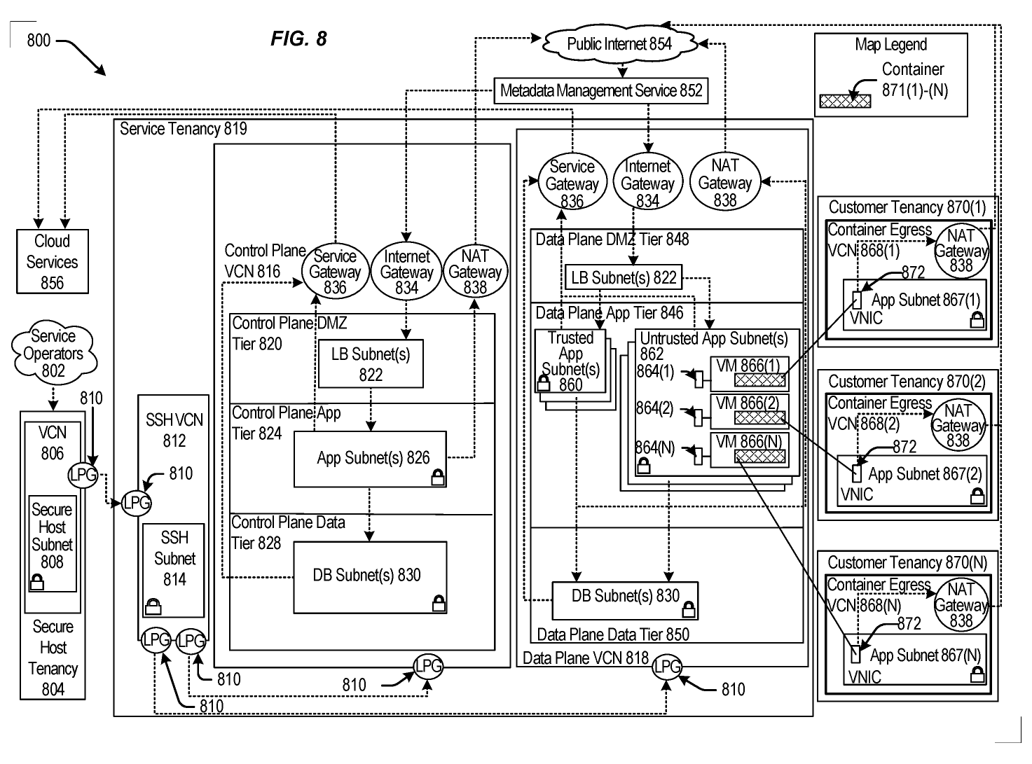

FIG. 8 is a block diagram 800 illustrating another example pattern of an IaaS architecture, according to at least one embodiment. Service operators 802 (e.g., service operators 602 of FIG. 6) can be communicatively coupled to a secure host tenancy 804 (e.g., the secure host tenancy 604 of FIG. 6) that can include a virtual cloud network (VCN) 806 (e.g., the VCN 606 of FIG. 6) and a secure host subnet 808 (e.g., the secure host subnet 608 of FIG. 6). The VCN 806 can include an LPG 810 (e.g., the LPG 610 of FIG. 6) that can be communicatively coupled to an SSH VCN 812 (e.g., the SSH VCN 612 of FIG. 6) via an LPG 810 contained in the SSH VCN 812. The SSH VCN 812 can include an SSH subnet 814 (e.g., the SSH subnet 614 of FIG. 6), and the SSH VCN 812 can be communicatively coupled to a control plane VCN 816 (e.g., the control plane VCN 616 of FIG. 6) via an LPG 810 contained in the control plane VCN 816 and to a data plane VCN 818 (e.g., the data plane 618 of FIG. 6) via an LPG 810 contained in the data plane VCN 818. The control plane VCN 816 and the data plane VCN 818 can be contained in a service tenancy 819 (e.g., the service tenancy 619 of FIG. 6).

The control plane VCN 816 can include a control plane DMZ tier 820 (e.g., the control plane DMZ tier 620 of FIG. 6) that can include load balancer (LB) subnet(s) 822 (e.g., LB subnet(s) 622 of FIG. 6), a control plane app tier 824 (e.g., the control plane app tier 624 of FIG. 6) that can include app subnet(s) 826 (e.g., similar to app subnet(s) 626 of FIG. 6), a control plane data tier 828 (e.g., the control plane data tier 628 of FIG. 6) that can include DB subnet(s) 830. The LB subnet(s) 822 contained in the control plane DMZ tier 820 can be communicatively coupled to the app subnet(s) 826 contained in the control plane app tier 824 and to an Internet gateway 834 (e.g., the Internet gateway 634 of FIG. 6) that can be contained in the control plane VCN 816, and the app subnet(s) 826 can be communicatively coupled to the DB subnet(s) 830 contained in the control plane data tier 828 and to a service gateway 836 (e.g., the service gateway of FIG. 6) and a network address translation (NAT) gateway 838 (e.g., the NAT gateway 638 of FIG. 6). The control plane VCN 816 can include the service gateway 836 and the NAT gateway 838.

The data plane VCN 818 can include a data plane app tier 846 (e.g., the data plane app tier 646 of FIG. 6), a data plane DMZ tier 848 (e.g., the data plane DMZ tier 648 of FIG. 6), and a data plane data tier 850 (e.g., the data plane data tier 650 of FIG. 6). The data plane DMZ tier 848 can include LB subnet(s) 822 that can be communicatively coupled to trusted app subnet(s) 860 and untrusted app subnet(s) 862 of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include one or more primary VNICs 864(1)-(N) that can be communicatively coupled to tenant virtual machines (VMs) 866(1)-(N). Each tenant VM 866(1)-(N) can be communicatively coupled to a respective app subnet 867(1)-(N) that can be contained in respective container egress VCNs 868(1)-(N) that can be contained in respective customer tenancies 870(1)-(N). Respective secondary VNICs 872(1)-(N) can facilitate communication between the untrusted app subnet(s) 862 contained in the data plane VCN 818 and the app subnet contained in the container egress VCNs 868(1)-(N). Each container egress VCNs 868(1)-(N) can include a NAT gateway 838 that can be communicatively coupled to public Internet 854 (e.g., public Internet 654 of FIG. 6).

The Internet gateway 834 contained in the control plane VCN 816 and contained in the data plane VCN 818 can be communicatively coupled to a metadata management service 852 (e.g., the metadata management system 652 of FIG. 6) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively coupled to cloud services 856.

In some embodiments, the data plane VCN 818 can be integrated with customer tenancies 870. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 846. Code to run the function may be executed in the VMs 866(1)-(N), and the code may not be configured to run anywhere else on the data plane VCN 818. Each VM 866(1)-(N) may be connected to one customer tenancy 870. Respective containers 871(1)-(N) contained in the VMs 866(1)-(N) may be configured to run the code. In this case, there can be a dual isolation (e.g., the containers 871(1)-(N) running code, where the containers 871(1)-(N) may be contained in at least the VM 866(1)-(N) that are contained in the untrusted app subnet(s) 862), which may help prevent incorrect or otherwise undesirable code from damaging the network of the IaaS provider or from damaging a network of a different customer. The containers 871(1)-(N) may be communicatively coupled to the customer tenancy 870 and may be configured to transmit or receive data from the customer tenancy 870. The containers 871(1)-(N) may not be configured to transmit or receive data from any other entity in the data plane VCN 818. Upon completion of running the code, the IaaS provider may kill or otherwise dispose of the containers 871(1)-(N).

In some embodiments, the trusted app subnet(s) 860 may run code that may be owned or operated by the IaaS provider. In this embodiment, the trusted app subnet(s) 860 may be communicatively coupled to the DB subnet(s) 830 and be configured to execute CRUD operations in the DB subnet(s) 830. The untrusted app subnet(s) 862 may be communicatively coupled to the DB subnet(s) 830, but in this embodiment, the untrusted app subnet(s) may be configured to execute read operations in the DB subnet(s) 830. The containers 871(1)-(N) that can be contained in the VM 866(1)-(N) of each customer and that may run code from the customer may not be communicatively coupled with the DB subnet(s) 830.

In other embodiments, the control plane VCN 816 and the data plane VCN 818 may not be directly communicatively coupled. In this embodiment, there may be no direct communication between the control plane VCN 816 and the data plane VCN 818. However, communication can occur indirectly through at least one method. An LPG 810 may be established by the IaaS provider that can facilitate communication between the control plane VCN 816 and the data plane VCN 818. In another example, the control plane VCN 816 or the data plane VCN 818 can make a call to cloud services 856 via the service gateway 836. For example, a call to cloud services 856 from the control plane VCN 816 can include a request for a service that can communicate with the data plane VCN 818.

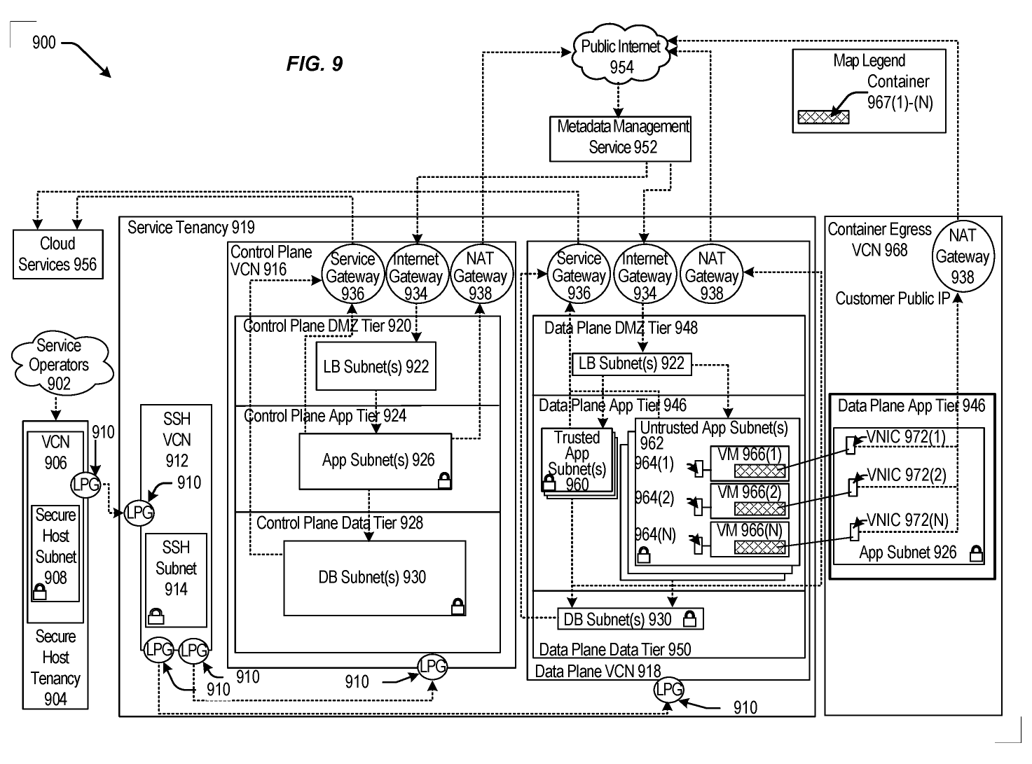

FIG. 9 is a block diagram 900 illustrating another example pattern of an IaaS architecture, according to at least one embodiment. Service operators 902 (e.g., service operators 602 of FIG. 6) can be communicatively coupled to a secure host tenancy 904 (e.g., the secure host tenancy 604 of FIG. 6) that can include a virtual cloud network (VCN) 906 (e.g., the VCN 606 of FIG. 6) and a secure host subnet 908 (e.g., the secure host subnet 608 of FIG. 6). The VCN 906 can include an LPG 910 (e.g., the LPG 610 of FIG. 6) that can be communicatively coupled to an SSH VCN 912 (e.g., the SSH VCN 612 of FIG. 6) via an LPG 910 contained in the SSH VCN 912. The SSH VCN 912 can include an SSH subnet 914 (e.g., the SSH subnet 614 of FIG. 6), and the SSH VCN 912 can be communicatively coupled to a control plane VCN 916 (e.g., the control plane VCN 616 of FIG. 6) via an LPG 910 contained in the control plane VCN 916 and to a data plane VCN 918 (e.g., the data plane 618 of FIG. 6) via an LPG 910 contained in the data plane VCN 918. The control plane VCN 916 and the data plane VCN 918 can be contained in a service tenancy 919 (e.g., the service tenancy 619 of FIG. 6).

The control plane VCN 916 can include a control plane DMZ tier 920 (e.g., the control plane DMZ tier 620 of FIG. 6) that can include LB subnet(s) 922 (e.g., LB subnet(s) 622 of FIG. 6), a control plane app tier 924 (e.g., the control plane app tier 624 of FIG. 6) that can include app subnet(s) 926 (e.g., app subnet(s) 626 of FIG. 6), a control plane data tier 928 (e.g., the control plane data tier 628 of FIG. 6) that can include DB subnet(s) 930 (e.g., DB subnet(s) 830 of FIG. 8). The LB subnet(s) 922 contained in the control plane DMZ tier 920 can be communicatively coupled to the app subnet(s) 926 contained in the control plane app tier 924 and to an Internet gateway 934 (e.g., the Internet gateway 634 of FIG. 6) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 6) and a network address translation (NAT) gateway 938 (e.g., the NAT gateway 638 of FIG. 6). The control plane VCN 916 can include the service gateway 936 and the NAT gateway 938.

The data plane VCN 918 can include a data plane app tier 946 (e.g., the data plane app tier 646 of FIG. 6), a data plane DMZ tier 948 (e.g., the data plane DMZ tier 648 of FIG. 6), and a data plane data tier 950 (e.g., the data plane data tier 650 of FIG. 6). The data plane DMZ tier 948 can include LB subnet(s) 922 that can be communicatively coupled to trusted app subnet(s) 960 (e.g., trusted app subnet(s) 860 of FIG. 8) and untrusted app subnet(s) 962 (e.g., untrusted app subnet(s) 862 of FIG. 8) of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include primary VNICs 964(1)-(N) that can be communicatively coupled to tenant virtual machines (VMs) 966(1)-(N) residing within the untrusted app subnet(s) 962. Each tenant VM 966(1)-(N) can run code in a respective container 967(1)-(N), and be communicatively coupled to an app subnet 926 that can be contained in a data plane app tier 946 that can be contained in a container egress VCN 968. Respective secondary VNICs 972(1)-(N) can facilitate communication between the untrusted app subnet(s) 962 contained in the data plane VCN 918 and the app subnet contained in the container egress VCN 968. The container egress VCN can include a NAT gateway 938 that can be communicatively coupled to public Internet 954 (e.g., public Internet 654 of FIG. 6).

The Internet gateway 934 contained in the control plane VCN 916 and contained in the data plane VCN 918 can be communicatively coupled to a metadata management service 952 (e.g., the metadata management system 652 of FIG. 6) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively coupled to cloud services 956.

In some examples, the pattern illustrated by the architecture of block diagram 900 of FIG. 9 may be considered an exception to the pattern illustrated by the architecture of block diagram 800 of FIG. 8 and may be desirable for a customer of the IaaS provider if the IaaS provider cannot directly communicate with the customer (e.g., a disconnected region). The respective containers 967(1)-(N) that are contained in the VMs 966(1)-(N) for each customer can be accessed in real-time by the customer. The containers 967(1)-(N) may be configured to make calls to respective secondary VNICs 972(1)-(N) contained in app subnet(s) 926 of the data plane app tier 946 that can be contained in the container egress VCN 968. The secondary VNICs 972(1)-(N) can transmit the calls to the NAT gateway 938 that may transmit the calls to public Internet 954. In this example, the containers 967(1)-(N) that can be accessed in real-time by the customer can be isolated from the control plane VCN 916 and can be isolated from other entities contained in the data plane VCN 918. The containers 967(1)-(N) may also be isolated from resources from other customers.

In other examples, the customer can use the containers 967(1)-(N) to call cloud services 956. In this example, the customer may run code in the containers 967(1)-(N) that requests a service from cloud services 956. The containers 967(1)-(N) can transmit this request to the secondary VNICs 972(1)-(N) that can transmit the request to the NAT gateway that can transmit the request to public Internet 954. Public Internet 954 can transmit the request to LB subnet(s) 922 contained in the control plane VCN 916 via the Internet gateway 934. In response to determining the request is valid, the LB subnet(s) can transmit the request to app subnet(s) 926 that can transmit the request to cloud services 956 via the service gateway 936.

It should be appreciated that IaaS architectures 600, 700, 800, 900 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

FIG. 10 illustrates an example computer system 1000, in which various embodiments may be implemented. The system 1000 may be used to implement any of the computer systems described above. As shown in the figure, computer system 1000 includes a processing unit 1004 that communicates with a number of peripheral subsystems via a bus subsystem 1002. These peripheral subsystems may include a processing acceleration unit 1006, an I/O subsystem 1008, a storage subsystem 1018 and a communications subsystem 1024. Storage subsystem 1018 includes tangible computer-readable storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative embodiments of the bus subsystem may utilize multiple buses. Bus subsystem 1002 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1004, which can be implemented as one or more integrated circuits (e.g., a conventional microprocessor or microcontroller), controls the operation of computer system 1000. One or more processors may be included in processing unit 1004. These processors may include single core or multicore processors. In certain embodiments, processing unit 1004 may be implemented as one or more independent processing units 1032 and/or 1034 with single or multicore processors included in each processing unit. In other embodiments, processing unit 1004 may also be implemented as a quad-core processing unit formed by integrating two dual-core processors into a single chip.

In various embodiments, processing unit 1004 can execute a variety of programs in response to program code and can maintain multiple concurrently executing programs or processes. At any given time, some or all of the program code to be executed can be resident in processor(s) 1004 and/or in storage subsystem 1018. Through suitable programming, processor(s) 1004 can provide various functionalities described above. Computer system 1000 may additionally include a processing acceleration unit 1006, which can include a digital signal processor (DSP), a special-purpose processor, and/or the like.

I/O subsystem 1008 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term "output device" is intended to include all possible types of devices and mechanisms for outputting information from computer system 1000 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1000 may comprise a storage subsystem 1018 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1004 provide the functionality described above. Storage subsystem 1018 may also provide a repository for storing data used in accordance with the present disclosure.

As depicted in the example in FIG. 10, storage subsystem 1018 can include various components including a system memory 1010, computer-readable storage media 1022, and a computer readable storage media reader 1020. System memory 1010 may store program instructions that are loadable and executable by processing unit 1004. System memory 1010 may also store data that is used during the execution of the instructions and/or data that is generated during the execution of the program instructions. Various different kinds of programs may be loaded into system memory 1010 including but not limited to client applications, Web browsers, mid-tier applications, relational database management systems (RDBMS), virtual machines, containers, etc.

System memory 1010 may also store an operating system 1016. Examples of operating system 1016 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1000 executes one or more virtual machines, the virtual machines along with their guest operating systems (GOSs) may be loaded into system memory 1010 and executed by one or more processors or cores of processing unit 1004.

System memory 1010 can come in different configurations depending upon the type of computer system 1000. For example, system memory 1010 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1010 may include a basic input/output system (BIOS) containing basic routines that help to transfer information between elements within computer system 1000, such as during start-up.

Computer-readable storage media 1022 may represent remote, local, fixed, and/or removable storage devices plus storage media for temporarily and/or more permanently containing, storing, computer-readable information for use by computer system 1000 including instructions executable by processing unit 1004 of computer system 1000.

Computer-readable storage media 1022 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1022 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1000.

Machine-readable instructions executable by one or more processors or cores of processing unit 1004 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to connect to one or more devices via the Internet. In some embodiments communications subsystem 1024 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1024 can provide wired network connectivity (e.g., Ethernet) in addition to or instead of a wireless interface.

In some embodiments, communications subsystem 1024 may also receive input communication in the form of structured and/or unstructured data feeds 1026, event streams 1028, event updates 1030, and the like on behalf of one or more users who may use computer system 1000.

By way of example, communications subsystem 1024 may be configured to receive data feeds 1026 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1024 may also be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1024 may also be configured to output the structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1000 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

1. A method, comprising:
receiving first data from a first datacenter in a first realm, the first data identifying a first value computed in the first realm for usage of a first resource by a first tenancy in the first realm, wherein the first value is computed in the first realm using first usage value parameters associated with the first tenancy for the first realm, the first realm comprising a first set of datacenters including the first datacenter;
receiving second data from a second datacenter in a second realm, the second data identifying a second value computed in the second realm for usage of a second resource by a second tenancy in the second realm, wherein the second value is computed in the second realm using second usage value parameters associated with the second tenancy for the second realm, the second realm comprising a second set of datacenters including the second datacenters, where the second set of datacenters are restricted from communicating with the first set of datacenters;
determining that the first tenancy in the first realm and the second tenancy in the second realm are associated with a first customer;
determining, based on at least one of the first value or the second value, that third usage value parameters apply for the first customer instead of the first usage value parameters; and
communicating third data to the first datacenter in the first realm, wherein the third data identifies the third usage value parameters.

2. The method of claim 1, further comprising:
determining, based on at least one of the first value or the second value, that fourth usage value parameters apply for the first customer instead of the second usage value parameters; and
communicating fourth data to the second datacenter in the second realm, wherein the fourth data identifies the fourth usage value parameters.

3. The method of claim 1, further comprising:
determining a combined value for the first customer based upon the first value and the second value; and
wherein determining that the third usage value parameters apply for the first customer instead of the first usage value parameters is based on the combined value.

4. The method of claim 1, wherein the first usage value parameters and the second usage value parameters are equal.

5. The method of claim 1, wherein the first value and the second value are determined for a first time period.

6. The method of claim 1, further comprising:
accessing a balance value for the first customer, wherein the balance value is a remaining portion of a commitment value for the first customer; and
updating the balance value using the first value and the second value.

7. The method of claim 6, wherein:
the commitment value is determined using subscription information for the first customer for the first resource and the second resource, wherein the subscription information includes one or more thresholds; and
further comprising:
communicating, to the first realm, the subscription information for the first customer to cause deletion of a first locally stored balance value in the first realm; and
communicating, to the second realm, the subscription information for the first customer to cause deletion of a second locally stored balance value in the second realm.

8. The method of claim 7, wherein determining, based on at least one of the first value or the second value, that the third usage value parameters apply for the first customer instead of the first usage value parameters comprises determining that the balance value satisfies a first threshold of the one or more thresholds.

9. The method of claim 7, wherein determining, based on at least one of the first value or the second value, that the third usage value parameters apply for the first customer instead of the first usage value parameters comprises:
determining a first total usage value for the first resource using the first value;
determining a second total usage value for the second resource using the second value; and
determining that the first total usage value or the second total usage value satisfies a first threshold of the one or more thresholds.

10. The method of claim 6, further comprising:
receiving, from the first realm, a first reservation request for the first resource;
updating the balance value using the first reservation request;
determining, based on the updated balance value, that fourth usage value parameters apply for the first customer instead of the third usage value parameters for the first realm; and
communicating fourth data to the first datacenter in the first realm, wherein the fourth data identifies the fourth usage value parameters.

11. The method of claim 1, further comprising:
accessing a balance value for a second customer, wherein the balance value is a remaining portion of a commitment value for the second customer;
communicating, to a third datacenter in a third realm, fourth data including information about the balance value for the second customer to cause balance value to be locally cached in the third realm, the second customer being associated with only the third realm;
receiving fifth data from the third datacenter in the third realm, the fifth data identifying a third value computed in the third realm for usage of a third resource by a third tenancy in the third realm, wherein the third value is computed in the third realm using fourth usage value parameters associated with the third tenancy for the third realm, the third realm comprising a third set of datacenters including the third datacenter; and
updating the balance value using the third value.

12. The method of claim 1, wherein:
the first data further comprises a message comprising:
the first data; and
fourth data identifying a third value computed in the first realm for usage of a third resource by the first tenancy in the first realm;
determining a combined value based on the first data and the fourth data;
determining, based on the combined value, that fourth usage value parameters apply for the first customer instead of the first usage value parameters, wherein the fourth usage value parameters includes a first parameter for the first resource and a second parameter for the second resource; and
communicating fifth data to the first datacenter in the first realm, wherein the fourth data identifies the fourth usage value parameters.

13. A non-transitory computer-readable storage medium storing instructions that, when executed by one or more processors, cause the one or more processors to perform operations including:
receiving first data from a first datacenter in a first realm, the first data identifying a first value computed in the first realm for usage of a first resource by a first tenancy in the first realm, wherein the first value is computed in the first realm using first usage value parameters associated with the first tenancy for the first realm, the first realm comprising a first set of datacenters including the first datacenter;
receiving second data from a second datacenter in a second realm, the second data identifying a second value computed in the second realm for usage of a second resource by a second tenancy in the second realm, wherein the second value is computed in the second realm using second usage value parameters associated with the second tenancy for the second realm, the second realm comprising a second set of datacenters including the second datacenters, where the second set of datacenters are restricted from communicating with the first set of datacenters;
determining that the first tenancy in the first realm and the second tenancy in the second realm are associated with a first customer;
determining, based on at least one of the first value or the second value, that third usage value parameters apply for the first customer instead of the first usage value parameters; and
communicating third data to the first datacenter in the first realm, wherein the third data identifies the third usage value parameters.

14. The non-transitory computer-readable storage medium of claim 13, wherein the operations further include:
accessing a balance value for the first customer, wherein the balance value is a remaining portion of a commitment value for the first customer; and
updating the balance value using the first value and the second value.

15. The non-transitory computer-readable storage medium of claim 14, wherein the operations further include:
receiving, from the first realm, a first reservation request for the first resource;
updating the balance value using the first reservation request;
determining, based on the updated balance value, that fourth usage value parameters apply for the first customer instead of the third usage value parameters for the first realm; and
communicating fourth data to the first datacenter in the first realm, wherein the fourth data identifies the fourth usage value parameters.

16. The non-transitory computer-readable storage medium of claim 13, wherein the operations further include:
the first data further comprises a message comprising:
the first data; and
fourth data identifying a third value computed in the first realm for usage of a third resource by the first tenancy in the first realm;
determining a combined value based on the first data and the fourth data;
determining, based on the combined value, that fourth usage value parameters apply for the first customer instead of the first usage value parameters, wherein the fourth usage value parameters includes a first parameter for the first resource and a second parameter for the second resource; and
communicating fifth data to the first datacenter in the first realm, wherein the fourth data identifies the fourth usage value parameters.

17. A system comprising:
one or more processors; and
one or more computer-readable storage media storing instructions which, when executed by the one or more processors, cause the one or more processors to perform operations including:
receiving first data from a first datacenter in a first realm, the first data identifying a first value computed in the first realm for usage of a first resource by a first tenancy in the first realm, wherein the first value is computed in the first realm using first usage value parameters associated with the first tenancy for the first realm, the first realm comprising a first set of datacenters including the first datacenter;
receiving second data from a second datacenter in a second realm, the second data identifying a second value computed in the second realm for usage of a second resource by a second tenancy in the second realm, wherein the second value is computed in the second realm using second usage value parameters associated with the second tenancy for the second realm, the second realm comprising a second set of datacenters including the second datacenters, where the second set of datacenters are restricted from communicating with the first set of datacenters;
determining that the first tenancy in the first realm and the second tenancy in the second realm are associated with a first customer;
determining, based on at least one of the first value or the second value, that third usage value parameters apply for the first customer instead of the first usage value parameters; and
communicating third data to the first datacenter in the first realm, wherein the third data identifies the third usage value parameters.

18. The system of claim 17, wherein the operations further include:
accessing a balance value for the first customer, wherein the balance value is a remaining portion of a commitment value for the first customer; and
updating the balance value using the first value and the second value.

19. The system of claim 18, wherein the operations further include:
receiving, from the first realm, a first reservation request for the first resource;
updating the balance value using the first reservation request;
determining, based on the updated balance value, that fourth usage value parameters apply for the first customer instead of the third usage value parameters for the first realm; and
communicating fourth data to the first datacenter in the first realm, wherein the fourth data identifies the fourth usage value parameters.

20. The system of claim 17, wherein the operations further include:
the first data further comprises a message comprising:
the first data; and
fourth data identifying a third value computed in the first realm for usage of a third resource by the first tenancy in the first realm;
determining a combined value based on the first data and the fourth data;
determining, based on the combined value, that fourth usage value parameters apply for the first customer instead of the first usage value parameters, wherein the fourth usage value parameters includes a first parameter for the first resource and a second parameter for the second resource; and
communicating fifth data to the first datacenter in the first realm, wherein the fourth data identifies the fourth usage value parameters.
